(19) United States
(12) Patent Application Publication
(10) Pub. No.: US 2024/0025004 A1
(43) Pub. Date: Jan. 25, 2024

(54) Hand-Held Power Tool

(71) Applicant: Robert Bosch GmbH, Stuttgart (DE)

(72) Inventors: Peter Molnar, Miskolc (HU); Gabriela Eurskens-Merz, Wolfschlugen (DE); Christian Koepf, Filderstadt (DE); Csaba Kiss, Arnot (HU); Szabolcs Gyori, Szeged (HU)

(21) Appl. No.: 18/041,658

(22) PCT Filed: Aug. 5, 2021
(86) PCT No.: PCT/EP2021/071836

§ 371 Date: Feb. 14, 2023

(30) Foreign Application Priority Data
Aug. 20, 2020 (DE) 10 2020 210 627.4

(51) Int. Cl. B24B 23/02; B23Q 9/00; B24B 27/08; B25F 5/02; B24B 47/12

(52) U.S. Cl. CPC B24B 23/028; B23Q 9/0007; B24B 27/08; B25F 5/021; B24B 47/12

(57) ABSTRACT

A hand-held power tool, in particular an angle grinder, includes a tool housing that includes a handle casing for holding the power tool as well as a drive casing, in particular arranged on the handle casing, for accommodating a drive unit operable in particular by means of a rechargeable battery unit. The drive unit has an input shaft, which is in particular mounted to be rotatable about an input axis, and an output shaft, which is in particular mounted to be rotatable about an output axis.

### PRIOR ART

The invention relates to a hand-held power tool according to the preamble of DE 10 2013 215 821 A1 discloses a hand-held power tool designed as an angle grinder comprising at least one electromotive drive, in particular an electronically commutated motor, which acts on an output shaft and is provided to drive a tool spindle, at least one first housing which is made up of at least one first housing half-shell and comprises at least a first housing part which accommodates the electromotive drive and a second housing part which serves as a handle, and a rechargeable battery serving as a power source, characterized in that a ratio of a diameter d1 of the electromotive drive to a diameter d2 of the second housing part is between 0.6 and 1.1, but preferably between 0.7 and 0.8.

### DISCLOSURE OF THE INVENTION

The object of the invention is to improve a hand-held power tool with simple design measures.

The object is achieved by a hand-held power tool, in particular an angle grinder, comprising a tool housing that includes a handle casing for holding the hand-held power tool as well as a drive casing, in particular arranged on the handle casing, for accommodating a drive unit operable in particular by means of a battery unit (39), the drive unit comprising an input shaft, which is in particular mounted to be rotatable about an input axis, and an output shaft, which is in particular mounted to be rotatable about an output axis.

It is proposed that the hand-held power tool is configured such that a cutting depth is maximized.

The drive unit should preferably be formed by an electric motor. An electric motor unit is preferably to be used having a rotational speed of more than 10,000, in particular more than 12,000, preferably more than 14,000, preferably more than 16,000, more preferably more than 17,000, such as about 18,000 revolutions per minute. Preferably, the drive unit can transmit a movement to the accessory device in such a way that the accessory device has a rotational speed of more than 3,000, in particular more than 4,000, preferably more than 5,000, and/or preferably less than 10,000, in particular less than 8,000, preferably less than 7,000, preferably less than 6,000, such as 5,800 revolutions per minute. The drive unit may be commutated electronically (EC drive) or mechanically (brush drive). It is clear that other types of drive units that appear to a person skilled in the art to be appropriate are also conceivable.

The tool housing can be formed from at least two housing half-shells. The handle casing and the drive casing can be joined to one another. The handle casing can be delimited by the drive casing. The drive casing can be arranged transversely, in particular perpendicularly, to the handle casing. The handle casing and the drive casing can be formed integrally. A housing half-shell can have a drive casing portion and a handle casing portion in each case, or in each case a “half” of the drive casing and of the handle casing.

The drive casing can be substantially of hollow-cylindrical design and extend substantially along the output axis and/or the input axis. In a section running transversely, in particular perpendicularly, to the input axis, the drive casing is designed to be substantially circular or elliptical.

The output axis can in particular be arranged eccentrically on a substantially circular or elliptical contour of the tool housing. In particular, the output axis can be arranged in the radial direction on a tool housing (portion) limiting the cutting depth, in particular in such a way that the cutting disk projects from the tool housing on a first side and does not project from the tool housing on a second side facing away from the first side.

The hand-held power tool, in particular the drive unit, may be operable by means of a battery unit. The hand-held power tool can have an in particular rechargeable battery unit. The battery unit can be designed as a power source. The battery unit can be provided to supply the hand-held power tool, in particular the drive unit, with electrical power. The battery unit is provided to store electrical power, in particular temporarily. The battery unit can have one or more battery cells. The battery unit can be designed as a battery pack.

The battery unit can be arranged in the handle casing. The battery unit can be surrounded by the handle casing. The battery unit can be arranged on or in the handle casing in such a way that removal of the battery unit is provided by disassembling the tool housing. The battery unit is preferably arranged in the tool housing in a fixed or non-removable manner. The battery unit can be detachably connectible to the tool housing. In particular, the hand-held power tool, in particular the tool housing, can have a battery interface which is accessible from the outside or without disassembly of the tool housing in order to couple the battery unit, and in particular to electrically connect it, to the battery interface. The battery unit can be installed in the tool housing and can preferably be accessible by disassembling the tool housing.

The battery unit can extend along an axis which coincides with a longitudinal axis of the tool housing or of the handle casing. The drive unit can extend along an axis which coincides with a transverse axis of the tool housing or the drive casing. In particular, the longitudinal axis can be arranged relative to the transverse axis at an angle of 60° to 120°, in particular of 70° to 110°, preferably of 80° to 100°, preferably of 85° to 95°, particularly preferably up to a tolerance variance of approximately 90°.

As a result, a particularly compact and safe hand-held power tool can be provided for one-handed operation. In particular when designing a particularly compact hand-held power tool, the dimensions of the hand-held power tool, in particular of the tool housing of the hand-held power tool, are to be reduced on the one hand and, on the other hand, a sufficiently large cutting depth is nevertheless to be achieved. In particular when using a large accessory device, this could come at the expense of handling and safety of the hand-held power tool. On the other hand, when a small accessory device is used a cutting depth is excessively reduced. In addition, a sufficiently powerful, in particular fast-rotating, and robust drive unit is required, which should not fall below a certain diameter.

The tool housing can be formed from two housing half-shells.

The dependent claims indicate alternative and/or further expedient developments of the hand-held power tool according to the invention.

It may further be expedient for the output shaft to be arranged parallel to the input shaft. Furthermore, it may be expedient for the output axis to be spaced apart from the input axis in the radial direction. The output shaft can be arranged on a side of the input shaft facing away from the handle casing. As a result, the output shaft and in particular the input axis can be moved closer to the tool housing that limits the cutting depth, in particular to the bearing surface of the tool housing.

It may be expedient for the tool housing to have a bearing surface for resting on a workpiece to be machined, wherein the first bearing surface is arranged closer to the output axis than to the input axis. In particular, the output axis of the output shaft has a first distance relative to the tool housing, in particular to the bearing surface of the tool housing, and the input axis of the input shaft has a second distance relative to the tool housing, in particular to the bearing surface of the tool housing, the second distance being more than 150%, in particular more than 180%, preferably more than 200%, preferably more than 250%, particularly preferably more than 300%, and/or less than 400%, in particular less than 300%, preferably less than 250%, larger than the first distance. Preferably, the ratio can be between 180% and 220% and in particular can be about 200%. Preferably, the second distance can be greater than the first distance. In particular, the output axis or the output shaft is arranged directly adjacent to the tool housing, in particular the bearing surface of the tool housing, preferably to maximize a cutting depth of the insertion tool. The output shaft can be arranged between the input shaft and the bearing surface of the tool housing.

The bearing surface can extend around the tool housing, in particular around a drive casing of the tool housing. The bearing surface can be formed on an end face of the tool housing. The bearing surface can be provided as a contact surface of the hand-held power tool for contacting a workpiece to be machined, which preferably contacts the workpiece during a machining operation. The bearing surface can limit a maximum extension of the hand-held power tool, in particular of the tool housing, preferably of the drive casing. The bearing surface can extend on the tool housing around the output axis. The bearing surface can limit a maximum cutting depth. The bearing surface can be arranged in the axial direction along the output axis in a kind of “slipstream” of the accessory tool. The accessory device can cover and/or intersect the bearing surface in the axial direction along the output axis. The bearing surface can extend on the tool housing, in particular the drive casing, in the axial direction along the output axis and in the circumferential direction around the output axis.

Furthermore, it may be expedient for the accessory device to project on a first side, in particular a cutting side, relative to the tool housing, in particular the drive casing, preferably the output surface, and to be set back relative to the tool housing, in particular the drive casing, on a second side facing away from the first side. In particular, it may be expedient that the drive casing has a height, in particular in a plane running parallel to the input axis and the output axis, and/or the output axis has a distance relative to the bearing surface, wherein the height of the drive casing is more than 50%, in particular more than 100%, preferably more than 150%, preferably more than 200%, particularly preferably more than 250%, more preferably more than 300%, and/or less than 350%, in particular less than 300%, preferably less than 250%, greater than the distance.

Furthermore, it may be expedient that the drive casing has a height, in particular in a plane running parallel to the input axis and the output axis, and the accessory device has a maximum diameter, wherein the height of the drive casing is greater than the diameter of the accessory device. As a result, it can be ensured that a sufficient cutting depth of the accessory device is achieved and the accessory device is preferably not projecting, or is set back, from the tool housing on a side facing away from the cutting side, thereby increasing safety for the operator.

Furthermore, it may be expedient for the hand-held power tool to have a gear unit which is provided to connect the output shaft to the input shaft. The gear unit can be designed as a spur gear unit. The gear unit can have a gear ratio of less than 6, in particular less than 5, preferably less than 4, preferably less than 3.5, and/or more than 1, in particular more than 1.5, preferably more than 2, preferably more than 2.5, and preferably of approximately 3. The output shaft can comprise a spur gear element having a diameter which is larger than a spur gear element of the input shaft. The spur gear element of the output shaft can extend in the radial direction at least in portions in or through the tool housing, in particular the drive casing. In this way, a particularly compact hand-held power tool can be formed which maximizes a cutting depth of the accessory device.

It is proposed that the output shaft is arranged on a side of the hand-held power tool, in particular of the input shaft, that faces away from the handle casing. The output shaft is arranged directly adjacent to the tool housing, in particular to a bearing surface of the tool housing. The output shaft is arranged adjacent to the tool housing such that, at least in portions, there is a minimum distance from the tool housing, in particular from a bearing surface of the tool housing. The minimum distance can be formed or limited substantially by a radial extension of the spur gear element.

It is further proposed that the output axis of the output shaft intersects the drive unit. It is further proposed that the output axis is spaced apart in the radial direction from the input axis such that the output axis or an extension of the output axis intersects the drive unit. In particular, the output shaft can be arranged in particular parallel to the input shaft such that the output axis is arranged or runs between the input axis and a maximum radial extension of the drive unit. A particularly compact arrangement can thereby be achieved. As a result, the available space can preferably be utilized particularly advantageously.

It is further proposed that the output shaft projects in portions in the radial direction in relation to the drive unit, in particular a maximum extension of the drive unit. In this case, a maximum radial extension of the output shaft can project beyond the drive unit.

Furthermore, the spur gear element of the output shaft can project in portions relative to the drive unit in the radial direction relative to the input axis. Furthermore, the output shaft can extend in the radial direction in such a way that a plane formed by a maximum radial extension of the drive unit lies between a plane formed by the output axis and a plane formed by the maximum radial extension of the output axis. The planes are arranged parallel to one another. The output shaft can have a first bearing portion, which is provided for accommodating a bearing element. The output shaft can have a second bearing portion, which is provided for accommodating a gear element. The first bearing portion can have a first diameter. The second bearing portion can have a second diameter. The second diameter can be greater than the first diameter. The second bearing portion can project relative to the drive unit at least in portions in the radial direction.

It may be expedient for the tool housing to have a recess which is provided to at least partially accommodate the gear unit, in particular a spur gear element of the output shaft. The tool housing has two housing half-shells. The housing half-shells delimit the recess in one plane by 360°. The recess can extend in the circumferential direction around the output axis from a first housing half-shell to a second housing half-shell. The recess can be arranged on a contact region of the first housing half-shell and the second housing half-shell. The spur gear element can extend through the recess at least in portions. The recess can be designed as an inspection opening which is provided for servicing the hand-held power tool. The recess can be provided to form a cavity in order to accommodate the gear unit, in particular the spur gear element, and to arrange the output shaft as close as possible to the bearing surface, in particular to increase a cutting depth. The recess is arranged on a side of the tool housing facing away in front of the handle casing, in particular in the drive casing.

Furthermore, it may be expedient for the gear unit to have a spur gear element which projects at least in portions in the radial direction relative to the recess and/or the housing half-shells forming the tool housing.

Furthermore, it may be expedient for the input shaft to be mounted in a floating manner. The input shaft can have a fixed end and a free or loose end remote from the fixed end. Preferably, the hand-held power tool or the tool housing has no support structure supporting the input shaft relative to the tool housing on a side of the input shaft facing away from the housing unit. The spur gear element is arranged on the loose end. As a result, a particularly compact hand-held power tool can be provided.

It is further proposed that the hand-held power tool has a bearing unit which is provided to mount the output shaft relative to the drive unit, in particular the input shaft. The bearing unit can be connected in a rotationally fixed manner to the drive unit, in particular a casing of the drive unit. The bearing unit can be connected to the drive unit in a form-fitting manner, in particular by means of a screw connection. The bearing unit can have a first bearing point, which is provided for mounting the output shaft. The first bearing point can be provided for accommodating a bearing element, in particular a roller bearing element. The bearing unit can have a second bearing point, which is provided for directly or indirectly mounting the input shaft. The second bearing point can be provided to accommodate a bearing element, in particular a roller bearing element, of the drive unit or the drive unit itself. The bearing unit can be connected in a form-fitting manner to the drive unit, in particular to the housing of the drive unit. The drive unit can have a bearing lobe. The bearing lobe can extend in the axial direction and delimit the drive unit. The bearing lobe can be provided for accommodating and surrounding the input shaft. The bearing lobe can be provided for accommodating a bearing element, in particular a roller bearing element, and for mounting it about the input axis. The second bearing point can be provided for accommodating the drive unit, in particular the bearing lobe of the drive unit, and for connecting it in a form-fitting manner at least in the radial direction.

The drive unit further comprises a connecting means, in particular a connection thread, which is provided to connect the bearing unit to the drive unit, for example by means of a screw connection. In particular, the drive unit can have a further connecting means, in particular a further connection thread, which is provided to connect the bearing unit to the drive unit, for example by means of a screw connection.

It may be expedient for a section extending transversely, in particular perpendicularly, to the output axis through the bearing unit to intersect with the input shaft and the output shaft. In particular, such a section can intersect the bearing element the first bearing point, in particular the bearing element of the output axis, and the second bearing point, in particular the bearing element of the input axis. The first and the second bearing points are arranged parallel to one another. The bearing unit separates the first bearing point from the second bearing point.

The invention further relates to a system made up of a hand-held power tool and an accessory device designed in particular as a cutting disk. The accessory device can project in the radial direction relative to the tool housing, in particular the drive casing, on a side of the hand-held power tool facing away from the handle casing and/or can be set back, or not project, in the radial direction relative to the tool housing, in particular the drive casing, on a side of the hand-held power tool facing the handle casing. By the accessory device being set back or not projecting relative to the tool housing on a side facing the handle casing, particularly safe and reliable handling of the hand-held power tool can be achieved.

The accessory device, in particular the cutting disk, can be arranged on the output shaft and can be driven about the output axis. Both the input axis and the output axis can be arranged parallel to one another and perpendicular to the accessory device. The input axis and the output axis or an extension of these axes can intersect both the accessory device and the drive unit.

It may be expedient for the hand-held power tool to have a bearing housing which is provided to surround, at least in portions, two housing half-shells forming the tool housing, and in particular to connect them in a form-fitting manner. The bearing housing can be provided to hold the housing half-shells together. The bearing housing can be provided to position and fix the housing half-shells relative to one another. The bearing housing can be connected to the first housing half-shell and/or to the second housing half-shell by means of a screw connection. The screw connection can have a screw axis which is arranged parallel to the output axis and/or to the input axis. The screw axis can be connected, parallel to a connecting plane separating the housing half-shells, by means of the screw connection to the housing half-shells. Screw connections are usually connected perpendicularly to a connecting plane of the housing half-shells in order to hold the housing half-shells together in a form-fitting manner. A screw connection can be provided in each case which connects the bearing housing to a housing half-shell.

Furthermore, it may be expedient for the bearing housing to be provided to surround the housing half-shells of the tool housing by 360° in one plane, in particular running perpendicular to the output axis. Preferably, the housing half-shells, in particular in a connected state, can form a housing opening in the tool housing. The housing opening can be delimited by the tool housing, in particular the housing half-shells. The housing opening can be at least substantially cylindrical. The housing opening can be provided for accommodating and preferably mounting the output shaft. The housing opening can be provided for guiding the output shaft out of the tool housing.

The housing half-shells can each have a housing wall which delimits the housing opening in the tool housing. The housing wall can be of hollow-cylindrical design and extend in the axial direction along the output axis. The housing wall can be formed from the two housing half-shells. The housing wall can be formed from two semicircular hollow-cylindrical housing portions of the housing half-shells. The housing wall can extend axially along the output axis and project outward on the tool housing.

Preferably, the bearing housing can cover at least 10%, in particular at least 20%, preferably at least 30%, preferably at least 40% of the drive casing.

As a result, an output shaft can be guided out to the outside or out of the tool housing in a particularly simple manner. By means of the bearing housing, a screw connection which connects the two housing half-shells may be dispensed with. The housing half-shells, and in particular the housing wall, can be surrounded by the bearing housing.

Furthermore, it may be expedient for the bearing housing to be provided to form-fittingly hold or hold together the housing half-shells in the radial direction relative to the output axis. The bearing housing can be provided to position or fix the housing half-shells relative to one another. The bearing housing can be connected to the first housing half-shell and/or to the second housing half-shell by means of a screw connection, in particular in the axial direction, preferably in the axial direction parallel to the output axis. The screw connection can have a screw axis which is parallel to the output axis and/or to the input axis. By means of the bearing housing, it can be ensured that the two housing half-shells are held together reliably and stably. As a result, the output shaft can be moved as close as possible to the tool housing, in particular a bearing region of the tool housing. It can thus be ensured that the housing half-shells are held together in a particularly robust manner. In particular, a kind of “gaping” of the housing half-shells in the region of the housing opening can be avoided by means of the bearing housing.

Usually, the two housing half-shells are screwed in within the region of the output shaft and preferably within a region in which the output shaft exits the tool housing. The use of a bearing housing makes it possible to dispense with a screw connection of the two housing half-shells to one another. This means that installation space can be optimized in order to guide the output shaft to the outside. In this way, a particularly simple and robust tool housing can be provided.

Furthermore, it may be expedient for the bearing housing to have a bearing receptacle, in particular a hollow-cylindrical bearing receptacle, and for the housing half-shells to form, in particular, a hollow-cylindrical housing portion, wherein the bearing receptacle is provided for accommodating the housing portion and, in particular, for securing it in a form-fitting manner in the radial direction. The hollow-cylindrical housing portion can be provided to surround the output shaft.

It is proposed that the tool housing is of double-walled design in the region of the housing portion of the housing half-shells surrounded by the bearing housing. In particular, the tool housing can be of double-walled design in the region of the output shaft. In particular, the tool housing is double-walled in a housing portion in which the output axis exits from the tool housing. The tool housing is double-walled in a portion in which the half-shell housing is covered by the bearing housing. The double-walled housing portion extends in the axial direction along the output axis. The double-walled housing portion limits an extension of the tool housing in the axial direction. A first wall can be formed by the housing wall of the tool housing or of the two housing half-shells. A second wall can be formed by the bearing housing, in particular the bearing receptacle of the bearing housing. The bearing receptacle is preferably of hollow-cylindrical design and is arranged coaxially around the housing wall.

It is further proposed that the tool housing is designed in a single-walled manner on a side of the drive casing that in particular faces away from the double-walled housing portion. Material can thereby be saved.

Furthermore, it may be expedient for the bearing housing to be provided to cover a recess in the housing half-shells and/or the gear unit, in particular the spur gear unit. The recess can be completely covered by the bearing housing. As a result, the output unit can be arranged closer to the tool housing in order to optimize the cutting depth. The bearing housing can have a housing extension which is provided to cover the recess and/or the spur gear unit. The housing extension can extend in the axial direction along a connecting plane of the two housing half-shells. The housing extension can be provided to cover the recess in such a way that a spur gear element arranged in the recess is protected from access. The housing extension can form a bearing surface for supporting the hand-held power tool.

It may be expedient for the bearing housing to be formed from a plastic material. As a result, the bearing housing can be produced particularly easily.

Furthermore, it may be expedient for the bearing housing to have a form-fit element which is provided to mount a guard device in a form-fitting manner on the bearing housing, in particular in the axial direction along the output axis. The form-fit element can extend in the radial direction toward the output axis. The form-fit element can be designed to be partially circular in relation to the output axis. The form-fit element can limit an extension of the bearing housing, in particular in the axial direction along the output axis. The form-fit element has a form-fit surface which contacts the guard device in order to hold the guard device on the bearing housing in a form-fitting manner. The form-fit surface has a surface normal which is oriented in a direction facing the hand-held power tool. The form-fit element can be provided to delimit the bearing housing. This can provide a particularly compact and robust connection of the guard device

Furthermore, it may be expedient for the bearing housing to have a guide device which is provided for accommodating a guard device and to mount it to be movable about the output axis. The guide device can extend in the circumferential direction around the output axis. The guide device can have a guide recess. The guide recess can extend in the axial direction along the output axis into the tool housing and then in the radial direction relative to the output axis. The guide recess can be L-shaped in cross section. The guide recess can be provided for accommodating a form-fit element of the guard device and for being delimited by the form-fit element. The guide recess can be formed by the form-fit element.

It may be expedient for an in particular maximum cutting depth of the hand-held power tool to be adjustable depending on a position, in particular an angular position, of the hand-held power tool, in particular relative to a workpiece to be machined.

A maximum cutting depth to be achieved can preferably be controlled by means of a movement, in particular a rotational movement, of the hand-held power tool, in particular of the tool housing of the hand-held power tool, relative to the workpiece. In particular, a rotation of the hand-held power tool about the input axis or about an output axis can be considered as a movement, in particular a rotational movement. A rolling movement can be regarded as a rotational movement, in which the hand-held power tool rolls on a bearing surface of the tool housing approximately around the input axis or the output axis.

The movement, in particular rotational movement, of the hand-held power tool can change a position, in particular an angular position, of the hand-held power tool in the circumferential direction about the output axis relative to the workpiece to be machined. Depending on the changed position, in particular angular position, an angle of the hand-held power tool relative to the workpiece changes, whereby a cutting depth is further limited or further released.

The maximum cutting depth is to be understood in particular as a cutting depth limitation which is defined substantially by the size, such as, for example, the diameter of the accessory device, and a distance of a maximum extension of the accessory device and of the tool housing, in particular a bearing region of the tool housing. A maximum cutting depth should be achievable in this case when an operator of the hand-held power tool performs a machining operation by lowering the hand-held power tool down to a stop, i.e., until the tool housing contacts the workpiece to be machined. If two different angular positions of the hand-held power tool are adopted for the workpiece to be machined, maximum cutting depths of different depths can be implemented. For example, in the case of a first angular position of the hand-held power tool, a first maximum cutting depth can be achieved and, in the case of a second rotational position of the hand-held power tool, a second maximum cutting depth can be achieved, wherein the first cutting depth is greater than the second cutting depth.

For example, the first maximum cutting depth can be achieved in that the hand-held power tool is provided in a first angular position, in which the hand-held power tool is arranged transversely, in particular perpendicularly, to a workpiece surface and assumes an angle of approximately 90°. In particular, a maximum cutting depth of approximately 14 mm can be achieved.

For example, the second maximum cutting depth can be achieved in that the hand-held power tool is provided in a second angular position in which the hand-held power tool is arranged transversely to a workpiece surface and assumes an angle of approximately 40°. For example, a maximum cutting depth of approximately at most 12 or 10 mm can be achieved.

The cutting depth can be specified in particular in that the accessory device projects from the tool housing at different distances depending on an angular position with respect to a workpiece, as a result of which a distance of a contour of the outer diameter of the accessory device relative to the tool housing, in particular a bearing surface of the tool housing, is changed, in particular enlarged or reduced.

In this way, an operator of the hand-held power tool can particularly advantageously adapt the maximum cutting depth. Particularly advantageously, a cutting depth can be adjusted without tools by means of the present invention, especially because no additional parts and also no additional devices for adjusting the cutting depth are required. An adjustment of the maximum cutting depth during a machining operation or during the operation of the hand-held power tool is also possible.

Furthermore, it may be expedient for the tool housing to be designed such that a plurality of positions, in particular angular positions, can be assumed by means of a movement, in particular a rotational movement of the hand-held power tool about the output axis relative to a workpiece.

Furthermore, it may be expedient for the tool housing to be designed such that the maximum cutting depth can be controlled by means of a movement, in particular a rotational movement, of the hand-held power tool about the output axis relative to a workpiece.

For example, a maximum cutting depth can be achieved when the hand-held power tool is aligned vertically on a workpiece. In this case, a first bearing point can be arranged on a side of the output shaft facing away from the input shaft. In this case, a short distance can be formed between the output axis and a bearing region or a bearing point or a bearing surface of the tool housing. As a result, the accessory device can project maximally relative to the tool housing in the radial direction relative to the output axis. In the case of a rotation of the hand-held power tool in the circumferential direction about the output axis and when the hand-held power tool is supported on a bearing point which is different from the first bearing point, or a second bearing point, the distance between the output axis and the further bearing point can change, in particular increase. In this case, a greater distance can be formed between the output axis and a bearing region or a bearing point or a bearing surface of the tool housing. As a result, the accessory device can project less far from the tool housing in the radial direction relative to the output axis.

In this way, a cutting depth can be set particularly easily and reliably.

Furthermore, it may be expedient for the tool housing to have a first bearing region and a second bearing region, wherein the bearing regions each define a distance of the bearing regions from the output axis. The bearing regions are designed as bearing edge portions or as bearing surface portions. The bearing regions can have a flat design. The bearing surface portions can have a flat design.

It is proposed that the first bearing region is spaced apart from the second bearing region. In particular, the first bearing region can directly adjoin the second bearing region.

It is further proposed that the first bearing region is designed as a first bearing surface, in particular a flat first bearing surface, which extends at least substantially tangentially to a bearing region of the tool housing that in particular defines the maximum cutting depth.

It is further proposed that the first bearing region has a first, in particular curved, bearing region portion and a second, in particular flat, bearing region portion. The first bearing region portion can adjoin the second bearing region portion in the circumferential direction around the tool housing. The first bearing region portion and the second bearing region portion can be provided to space apart the hand-held power tool relative to the workpiece in such a way that the same or a constant maximum cutting depth is achieved. The first bearing region portion can have a first bearing point with a first distance from the output axis. The second bearing region portion can have a second bearing point with a second distance from the output axis. In particular, the second distance can be greater than the first distance. Preferably, the first bearing region portion and the second bearing region portion can each have a bearing point which has the same distance from the output axis. The first bearing region portion can have a plurality of bearing points, in particular spaced apart from one another, which have the same distance from the output axis. The second bearing region portion can have a plurality of bearing points, in particular spaced apart from one another, which are of different sizes. This can ensure that a maximum cutting depth remains constant over a larger peripheral region.

It may be expedient for the second bearing region to be designed as an in particular flat second bearing surface, wherein the first bearing region, in particular the second bearing region portion of the first bearing region, is angled relative to the second bearing region.

In particular, the second bearing region has a plurality of bearing points, in particular spaced apart from one another, which each have distances to the output axis that are of different sizes in relation to one another. In other words, the bearing points of the second bearing region, which are in particular spaced apart from one another, are at different distances from the output axis.

Furthermore, it may be expedient for the tool housing to be formed substantially symmetrically, in particular so that at least one further first and second bearing region is arranged on a side of the tool housing that faces away from the first and second bearing regions. A plane of symmetry can be formed by a plane running parallel to the output axis and the input axis. As a result, the hand-held power tool can be used particularly reliably even under difficult space conditions.

Furthermore, it may be expedient for the accessory device to substantially cover the second bearing region in the axial direction with respect to the output axis. A plane delimiting the accessory device in the radial direction and extending in the axial direction with respect to the output axis intersects the second bearing region.

It is further proposed that the hand-held power tool, in particular the tool housing, has an intermediate bearing region with an in particular curved intermediate bearing edge and/or intermediate bearing surface, which is arranged between the first bearing region and the second bearing region. It is further proposed that the intermediate bearing region is designed as a lobe. As a result, the operator of the hand-held power tool can easily recognize that a maximum cutting depth changes when the lobe is overcome.

Furthermore, it may be expedient for the tool housing to be designed in such a way that a maximum cutting depth can be achieved in a pivot range/angular range of up to 140°, in particular of 120°, preferably of 100°. In particular, the accessory device is in an angular range of up to 140°, in particular up to 120°, preferably up to 100°, relative to the tool housing in such a way that a maximum cutting depth is achieved.

It may be expedient for the hand-held power tool to have a support device, in particular formed by the tool housing, which is provided to support the hand-held power tool in an operating state.

The support device can be provided to hold the hand-held power tool in an operating state in a predetermined cutting position, in particular a predetermined cutting angle position. In particular, a vertical cut (cutting angle position of 90°) is to be achieved by means of the support device, for which cut the accessory device is preferably oriented perpendicular to a surface of the workpiece to be machined and is held in this orientation by means of the support device. Preferably, this vertical cut is to be maintained during a guidance of the hand-held power tool along a cutting direction or along the surface of the workpiece to be machined. In particular, the support device should ensure that a vertical cut of the accessory device is maintained by the support device resting on the workpiece to be machined and preventing a tilting movement or an in particular rotational movement about the cutting direction of the hand-held power tool. In this way, a straight cut along a cutting direction can be achieved in a particularly advantageous manner.

For example, the accessory device can plunge into the workpiece to be machined by means of a plunging movement in a plunging direction, in particular perpendicularly, in such a way that the support device comes into contact with the workpiece. Furthermore, the hand-held power tool can be moved along a cutting direction or along the workpiece or parallel to a surface of the workpiece in such a way that a tilting movement around the cutting direction is avoided by means of the support device.

As a result, a clean vertical cut can be carried out without the accessory device jamming with the workpiece, in particular a cutting gap of the workpiece, on account of tilting movements or lateral movements. Particularly advantageously, the hand-held power tool can be guided along the cutting plane and held in the predetermined position by means of the support device. A tilting movement of the hand-held power tool can be limited particularly reliably by means of the support device.

A tilting movement is to be understood in particular as a movement which leads to a change in a cutting angle, preferably during a cutting operation, by the accessory device for example tilting away laterally and becoming clamped in a cutting gap.

It is proposed that the support device is provided to limit an in particular maximum cutting depth of the accessory device. The support device can form a depth stop. In this way, a cutting depth can be defined in a particularly simple and intuitive manner.

It is proposed that the support device has a first support element which is provided to form a support plane for supporting the hand-held power tool on a workpiece to be machined. The first support element can be designed as a support point, a support line and/or a support surface. The first support element or the first support elements can be provided to form a point, line and/or surface contact with the workpiece. It is clear that the support device can comprise a single number or a plurality of first support elements. It is clear that a plurality of support elements can be provided which form a support plane. In particular, a plurality of support elements can be provided which, in the case of common contact with the workpiece, form a support plane. The support elements can form a bearing contact on the tool housing of the hand-held power tool.

The support plane can be parallel to a tangent extending tangentially to a circumferential direction around the output axis.

It is further proposed that the support device has a first support element which is arranged on the tool housing, in particular on the housing half-shell. In particular, the first support element can be formed by the tool housing. The first support element can be formed integrally with the tool housing. The first support element can limit an extension of the tool housing. The first support element can be formed on the bearing housing and/or on the housing half-shell.

It is further proposed that the first support element is designed as a support line or a support surface which is formed by a bearing surface of the tool housing that is curved in particular around the output axis. The support line or the support surface can extend parallel to the output axis. The support line or the support surface can extend orthogonally to the accessory device or to a cutting plane of the accessory device. The support line or support surface is preferably provided to form a line contact or a surface contact with a workpiece to be machined.

Furthermore, it may be expedient for the first support element to be arranged on a side of the hand-held power tool facing away from the accessory device, in particular on the tool housing of the hand-held power tool. In particular, the first support element can extend relative to a maximum extension of the tool housing, in particular parallel to the output axis, by at least 10%, in particular at least 20%, preferably at least 30%, preferably at least 40%, more preferably at least 50%, particularly preferably at least 60%, and/or by a maximum of 100%, in particular 95%, preferably 90%, preferably 80%, more preferably 70%, particularly preferably 60%. The maximum extension of the tool housing, in particular parallel to the output axis, can have a first end facing the accessory device and a second end remote from the first end. The first support element can be spaced apart from the first end and/or from the second end. The support element can be spaced apart from the first end. The support element can be arranged at a second end or in the region of a second end. The support element can be arranged on the drive casing.

It is proposed that a support plane formed by the support elements is arranged parallel to the output axis.

It is further proposed that the support element extends parallel to the output axis. It is further proposed that the support element is spaced apart from the output shaft in the axial direction along the output axis. Furthermore, it may be proposed that the support element is arranged in the axial direction along the output axis between a maximum extension of the input shaft, in particular between the bearing elements of the input shaft.

Furthermore, it may be expedient for the support element to be arranged on a side of the tool housing, in particular of the drive casing, that faces away from the handle casing. Furthermore, it may be expedient that a longitudinal axis extending along the hand-held power tool, in particular the handle casing, intersects the support element. As a result, a force can be exerted on the hand-held power tool in a particularly advantageous manner, which force is preferably introduced along the longitudinal axis of the hand-held power tool into the workpiece to be machined, resulting in tilting stability. Preferably, this can prevent a moment, in particular a tilting moment, being generated.

It may be expedient for the hand-held power tool to have a guard device and a support device, in particular formed by the guard device, which is provided to support the hand-held power tool in an operating state.

As a result, a tilting movement of the hand-held power tool during an operating state or a cutting operation can be avoided.

It may further be expedient for the guard device to be connected in a form-fitting manner to the tool housing, in particular a drive casing, preferably a bearing housing, and to be provided to cover the accessory device at least in portions.

Furthermore, it may be expedient for the support device to have a second support element which is arranged on the guard device. It is clear that the guard device can have a single number or a plurality of second support elements. In particular, the second support element can be formed by the guard device. The second support element can be formed integrally with the guard device.

Furthermore, it may be expedient for the guard device to extend in the axial direction along the output axis from a first side of the accessory device to a second side facing away from the first side. The guard device can be provided to surround the accessory device, in particular in the axial direction along the output axis. The guard device can be provided to surround the accessory device in the circumferential direction around the output axis, in particular substantially.

Furthermore, it may be expedient for the guard device to have a second support element which is arranged in relation to the accessory device on a first side of the guard device, and a third support element which is arranged in relation to the accessory device on a second side of the guard device facing away from the first side. It may be provided that a support element extends from a first side to a second side or a support element is arranged on a first side and a third support element is arranged on a second side. For example, third support element can be arranged on a side of the accessory device facing away in front of the tool housing, and a second support element can be arranged on a side of the accessory device facing the tool housing. As a result, a tilting movement of the hand-held power tool can be limited particularly reliably by a support element being provided on both sides of the accessory device and thus providing support on both sides.

Furthermore, it may be expedient for the second support element to limit an extension of the guard device, in particular in a circumferential direction around the output axis. In particular, two support elements can be provided which limit the guard device in the circumferential direction around the output axis.

It may be expedient for the guard device to have a first end and a second end opposite the first end in the circumferential direction around the output axis, with a support element being arranged at both ends.

Furthermore, it may be expedient for the support elements to be formed on the two ends as support surfaces and, in particular, to be oriented parallel to one another.

Furthermore, it may be provided that the support elements, in particular the guard device and the tool housing, are arranged parallel to one another. Furthermore, it may be provided that the support element of the guard device, in particular designed as a support surface, is arranged parallel to a support element of the tool housing, in particular designed as a support line or support surface. In particular, the support element of the guard device and the support element of the tool housing can form a support plane which is arranged parallel to the output axis. In this way, a particularly advantageous support function can be achieved.

It may be expedient for the support element or the support elements to be spaced apart from the output axis.

It may be expedient for the guard device to be connected to the tool housing, in particular in a form-fitting manner. The guard device can be connected to the tool housing in a form-fitting manner axially relative to the output axis and radially along the output axis.

Furthermore, it may be expedient for the guard device to be mounted so as to be movable relative to the tool housing in the circumferential direction around the output axis. As a result, it can be ensured that the support element(s) rest optimally on the workpiece to be machined irrespective of an angular position of the hand-held power tool.

It may be expedient for the hand-held power tool to have a guard device with a form-fit element which is provided to form a form-fit with the tool housing, in particular the bearing housing of the tool housing.

The tool housing can have a guide device which is provided for accommodating the form-fit element and for mounting it to be movable about the output axis. The guide device can have a guide recess. The guide recess can extend in the axial direction along the output axis into the tool housing and then in the radial direction relative to the output axis. The guide recess can be L-shaped in cross section. The guide device can extend in the circumferential direction around the output axis.

Furthermore, it may be expedient for the form-fit element to be designed as a lobe extending in the radial direction relative to the output axis. The form-fit element can extend in the radial direction toward the output axis. The form-fit element can be designed to be partially circular in relation to the output axis. The form-fit element can limit an extension of the guard device, in particular in the axial direction along the output axis. The form-fit element has a form-fit surface which contacts the tool housing in order to hold the guard device in a form-fitting manner on the tool housing. The form-fit surface has a surface normal which is oriented in a direction facing away from the hand-held power tool. The form-fit element can be provided to engage around the tool housing. The form-fit element can be provided to be guided with the guide device. The form-fit element can be provided to engage in the guide device designed as a guide recess, or to be accommodated thereby. The form-fit surface can be supported on a side wall of the guide device and/or form a form-fit therewith, in particular in the axial direction along the output axis. The form-fit surface and the side wall can extend transversely, in particular perpendicularly, to the output axis. As a result, a particularly compact and robust connection of the guard device can be provided.

Furthermore, it may be expedient for the guard device to have a further form-fit element which is spaced apart from the form-fit element in the circumferential direction, in particular around the output axis. The further form-fit element can have a further form-fit surface. The form-fit elements, in particular the form-fit surfaces, can be arranged parallel to one another. As a result, a compact and material-saving guard device can be provided.

Furthermore, it may be expedient for the form-fit element or the form-fit elements to form a shaped collar. The shaped collar can extend in the circumferential direction around the output axis. The shaped collar can assume a partially circular extension in the circumferential direction around the output axis. The partially circular extension can extend at an angle of more than 180°, in particular more than 210°, more than 240°, and/or less than 300°, in particular less than 270°, preferably less than 240°, and can preferably assume an angle of approximately 225°. The shaped collar can assume a C-shaped extension. The shaped collar can be formed from a plurality of form-fit elements which extend in the circumferential direction and are spaced apart from one another. The form-fit element can have an extension in the circumferential direction around the output axis. The form-fit element can have a distance in the circumferential direction around the output axis from a further form-fit element or from an adjacent form-fit element. In particular, the distance can be greater than the extension of the form-fit element. The form-fit element, in particular each form-fit element, can extend in the circumferential direction relative to the output axis by an angular range of 10° to 90°, in particular of 15° to 70°, preferably of 20° to 50°, preferably of 25° to 40°, particularly preferably of 25 to 35°, and, for example, can assume an angle of approximately 30°. As a result, the shaped collar can form a plurality of bearing points and, not least, reduce friction of the forming collar during a movement in the guide device. Furthermore, material can be saved and the environment can be protected.

It may be expedient for the guard device to have a guard collar which is provided to surround the accessory device in portions. The guard collar is provided for surrounding the accessory device in the axial direction along the output axis and in the circumferential direction around the output axis. The guard collar can cover the accessory device from a side facing the tool housing and expose it from a side facing away from this side. As a result, an operator of the hand-held power tool can be particularly reliably protected.

Furthermore, it may be expedient for the guard device to have a connecting element, in particular of hollow-cylindrical shape in portions, which connects the shaped collar, in particular the form-fit element/the form-fit elements, to the guard collar. The connecting element extends in the circumferential direction around the output axis and/or in the axial direction along the output axis. The connecting element limits a radial extension of the guard device. The connecting element can have a contact surface for resting the guard device on the tool housing on a side facing away from the guard collar and/or the shaped collar. The contact surface can define a contact radius.

The guard device can have a recess. The recess can be arranged in particular in the axial direction relative to the form-fit element. The recess can be assigned to the form-fit element. The recess can be arranged on the guard collar. As a result, material can reliably be saved and the environment can be protected.

Furthermore, it may be expedient for the guard device to be mounted on the tool housing, in particular the guide device of the tool housing, so as to be rotatable about the output axis. The guard device can assume a plurality of rotational positions relative to the tool housing and/or can be connected in a latchable manner in these rotational positions.

Furthermore, it may be expedient for the hand-held power tool to have a latching device which is provided to adjust or to define a rotational position of the guard device relative to the tool housing in the circumferential direction around the output axis. The latching device can limit a rotational movement of the guard device in the circumferential direction, in particular in a clockwise direction and a counter-clockwise direction, in particular in a form-fitting manner.

It may be expedient for the latching device to have a stop element which limits a rotational movement of the guard device relative to the tool housing of the hand-held power tool. The stop element can extend in the radial direction relative to the output axis and preferably form a stop surface. The stop surface can form a form-fit stop. The stop should preferably form a barrier with a counter stop. Analogously to the stop element, the latching device can have a further stop element which limits a rotational movement of the guard device relative to the tool housing of the hand-held power tool. The stop element can be arranged on a first side of the guard device. The further stop element can be arranged on a second side of the guard device facing away from the first side in the circumferential direction. The two stop elements have stop surfaces which face one another in the circumferential direction, as a result of which the stop elements, in particular by means of a counter stop element, limit a rotational movement of the guard device in the circumferential direction around the output axis. As a result, it can be ensured that the guard device does not carry out an impermissibly large rotational movement even in a burst-wheel case, in which the accessory device bursts and the bursting parts of the guard device can put the guard device into a rotational movement. This can prevent the guard device from being removed from the tool housing in order to ensure safe handling.

Furthermore, it may be expedient for the latching device to have a first latching element which is arranged on the tool housing, in particular the bearing housing. The first latching element can be designed as a latching pin. The first latching element can extend in the axial direction along the output axis and/or project from the tool housing. The first latching element can be mounted to be movable in the axial direction along the output axis, in particular resiliently, preferably by means of a spring element. The first latching element can be arranged in a recess of the tool housing and/or can preferably be mounted to be movable along this recess. The first latching element may be provided to extend up to the guard device and to contact it and preferably exert a force thereon in an operating state.

Furthermore, it may be expedient for the latching device to have a second latching element which is arranged on the guard device, in particular the guard collar of the guard device. The second latching element extends in the circumferential direction around the output axis along the guard device, in particular a side surface of the guard device. The second latching element has a plurality of latching portions which each form a latching position of the latching device, in particular of the first latching element. The latching portions are spaced apart from one another and/or extend along the second latching element. The latching portions are substantially circular in cross section. The second latching element can be limited in the circumferential direction around the output axis by the stop elements. The latching portions are formed in a latching recess??? in which the first latching element engages in order to latch the guard device in a rotational position.

The guard device has a groove in which the latching portion is arranged.

The guard device can have an unlocking recess which is intended to move the guard device out of out of a relaxed position.

Hand-held power tool, in particular an angle grinder, comprising a tool housing, which has a handle casing for holding the hand-held power tool as well as a drive casing, in particular adjoining the handle casing, for accommodating a drive unit, and comprising a power supply, in particular a battery, for supplying the hand-held power tool with electrical power, wherein the drive unit comprises an input shaft which is mounted in particular to be rotatable about an input axis and is provided for driving an accessory device.

It may be expedient for the tool housing to have an air inlet opening and an air discharge opening which are arranged adjacent to one another. The air inlet opening and the air discharge opening are preferably arranged directly adjacent to one another. The air inlet opening and the air discharge opening can be arranged on one side of the tool housing, in particular the same side. The housing openings can be provided on the drive casing and extend substantially in a peripheral side of the drive casing.

It is clear that the drive unit has a fan unit, in particular surrounded by a motor housing, which is provided to generate an air flow, in particular an air input flow and an air output flow. For this purpose, the fan unit can have an air wheel element which is driven, for example, by the drive unit, in particular the input shaft, in order to generate an air flow.

The air inlet opening and the air discharge opening can extend substantially in the circumferential direction around the output axis. The air inlet opening and the air discharge opening can extend in the axial direction.

It may be expedient for the hand-held power tool to have an air deflecting web which separates the air inlet opening from the air discharge opening. Furthermore, it may be expedient for the air deflecting web to be provided for delimiting, in particular at least partially delimiting, an extension of the air inlet opening and/or the air discharge opening. The air deflecting web can be arranged between two housing openings.

Furthermore, it may be expedient for the hand-held power tool to have a partition wall which is provided for separating an air flow of the air inlet opening from an air flow of the air discharge opening. In particular, the partition wall can adjoin the air deflecting web or be delimited thereby, in particular in the radial direction relative to the output axis. The partition wall can extend from the air deflecting web to the drive unit, in particular to a casing of the drive unit or of the motor unit. The partition wall can be provided to delimit an air flow channel. Furthermore, a further partition wall can be provided which, in particular in the axial direction along the input axis, is spaced apart from the partition wall. The further partition wall can be provided to delimit an air flow channel. The partition wall can be arranged upstream of the air discharge opening in the axial direction, and the further partition wall can be arranged downstream of the air discharge opening in the axial direction. The partition walls can be provided to form a flow channel or a flow chamber for an air discharge flow. This can ensure that warm air is quickly transported away.

Furthermore, it may be expedient for the partition wall to extend radially, in particular inward, up to the drive unit. The partition wall can surround the drive unit by 360° in one plane. The partition wall can be provided to separate, in particular seal off, a flow chamber assigned to the air discharge opening from a flow chamber assigned to the air inlet opening. A particularly compact air cooling system can be achieved thereby.

Furthermore, it may be expedient for the partition wall to be provided to surround the drive unit, in particular to surround it by 360° in one plane.

It may be expedient for the drive unit, in particular a motor housing of the drive unit, to have an air entry opening and an air exit opening.

The air entry opening can be provided to guide an air flow out of the tool housing into the motor housing. The air entry opening can be arranged on an end face of the drive unit, in particular of the motor housing. The air entry opening can be provided to guide an air flow along the input axis in the axial direction in order to cool the drive unit.

The air exit opening can be provided to guide an air flow out of the motor housing into the tool housing. The air exit opening can be arranged on a peripheral side of the drive unit, in particular of the motor housing. The air exit opening can be provided to guide an air flow out of the drive unit in the radial direction relative to the input axis in order to guide a warm air flow as quickly as possible out of the drive unit or the motor housing.

The drive unit, in particular a motor housing of the drive unit, can have a further air entry opening and a further air exit opening. The further air entry opening can be arranged on a side of the drive unit, in particular the motor housing, facing away from the air entry opening. The further air exit opening can be arranged on a side of the drive casing, in particular the motor housing, facing away from the air exit opening.

Furthermore, it may be expedient for the air exit opening of the drive unit, in particular the motor housing, to at least partially cover the air inlet opening. Furthermore, it may be expedient for the air discharge opening of the tool housing to be arranged opposite the air exit opening of the drive unit, in particular the motor housing, in such a way that a radial plane extending radially with respect to the input axis intersects the air discharge opening of the tool housing and the air exit opening of the drive unit, in particular the motor housing. In this way, warm air can be conveyed out of the hand-held power tool or the drive unit and the tool housing particularly quickly and reliably.

Furthermore, it may be provided that the air inlet opening and the air discharge opening are arranged on a side of the tool housing, in particular a drive casing, facing away from an actuating element. As a result, it can be ensured that the air flow does not flow against the operator. In particular, this air flow may be disruptive in that an operator would have to blink more frequently. However, dust may be carried along in the air flow, which is likewise perceived as disruptive for an operator.

Furthermore, it may be expedient for a further air inlet opening to be provided which is arranged on an end face of the drive unit facing away from the air inlet opening and is provided for cooling the gear unit, in particular the spur gear elements.

Hand-held power tool, in particular an angle grinder, comprising a tool housing, which has a handle casing for holding the hand-held power tool as well as a drive casing, in particular adjoining the handle casing, for accommodating a drive unit, and comprising a power supply, in particular a battery, for supplying the hand-held power tool with electrical power, wherein the drive unit comprises an input shaft which is mounted in particular to be rotatable about an input axis and is provided for driving an accessory device.

It may be expedient for the tool housing to have two housing half-shells forming the handle casing with two ends facing away from one another and a connecting region formed between the ends, wherein the connecting region is provided to connect the two housing half-shells by means of a snap connection, in particular in a form-fitting manner.

A snap connection is intended in particular to be a connection comprising at least one snap element which is elastically deflected during a fastening operation in order to subsequently snap in behind a corresponding holding element or a corresponding counter snap element by means of an internal clamping force. The snap connection preferably has a snapping means. The snapping means can be understood as a resilient means for producing a snap connection which is intended to be elastically deflected during assembly.

By means of a snap connection arranged in this way, the two housing half-shells can be joined particularly reliably. In particular, a handle circumference can be particularly optimized or compact, in that a screw connection typically used in the region of the handle casing may be dispensed with, thereby enabling a narrower design of the handle casing.

It may be expedient for the snap connection to be formed from a snap element and a holding element accommodating the snap element. It is clear that a single number or a plurality of latching elements can be provided.

Furthermore, it may be expedient for the snap connection to have at least two snap elements which are arranged on two sides of a first housing half-shell facing away from one another. The snap elements can project from the first housing half-shell. The snap elements can extend in the direction of the second housing half-shell. The snap elements can delimit an extension of the housing half-shell. The snap elements can be provided to project into the further housing half-shell in an assembled state and to be accommodated in with the holding element.

The snap elements can each have a snap hook. The snap hook can be provided to be accommodated with the holding element, in particular a holding recess of the holding element. The snap elements can have a snapping means. The snapping means can be arranged between the snap hook and the first housing half-shell. The snapping means can be provided to mount the snap hook resiliently. The snapping means can be provided to deflect the snap hook elastically into a deflection state from an initial state and to return it to the initial state by means of elastic energy.

Preferably, the snapping means can be provided to form-fittingly connect the second housing half-shell, in particular in a direction transverse to, in particular perpendicular to, the latching means. The latching means can rest against the second housing half-shell and in particular directly contact it. The snapping means or the snap elements can pre-tension the second housing half-shell, in particular in a tensioning direction in each case which are oriented facing away from one another. In this case, pre-tensioning can be applied to the second housing half-shell by means of the first housing half-shell. A lateral relative movement of the housing half-shells can be particularly advantageously pre-tensioned by means of the snap element which extends into the second housing half-shell.

Furthermore, it may be expedient for the snap connection to be arranged directly adjacent to a battery unit. By using the snap elements, a very flat and space-saving connection of the two housing half-shells can be realized.

Furthermore, it may be expedient for a section running transversely, in particular perpendicularly, to a longitudinal extension of the handle casing to intersect the snap connection and the battery unit.

Furthermore, it may be expedient for the two housing half-shells to be connected at the two ends by means of a screw connection.

### BRIEF DESCRIPTION OF THE DRAWINGS

Further advantages result from the following description of the drawings. Exemplary embodiments of the invention are shown in the drawings. The drawings, the description, and the claims contain numerous features in combination. A person skilled in the art will expediently also consider the features individually and combine them to form meaningful further combinations. In the drawings:

FIG. 1 shows a view of a hand-held power tool according to the invention,

FIG. 2 shows a further view of a hand-held power tool,

FIG. 3 shows a section through the hand-held power tool,

FIG. 4 shows a further view of a hand-held power tool,

FIG. 5 shows a further view of a hand-held power tool,

FIGS. 6 to 10 each show a view of the tool housing,

FIGS. 11 to 15 each show a view of the hand-held power tool,

FIG. 16 shows a view of a guard device,

FIG. 17 shows a view of a bearing housing,

FIGS. 18 to 20 show a view of a hand-held power tool,

FIG. 21 shows a section through the hand-held power tool,

FIGS. 22 to 24 each show a further view of a hand-held power tool,

FIG. 25 shows a section through a hand-held power tool,

FIGS. 26 to 28 show a view of the hand-held power tool.

FIG. 29 shows a section through a hand-held power tool.

In the following figures, identical components are provided with the same reference signs.

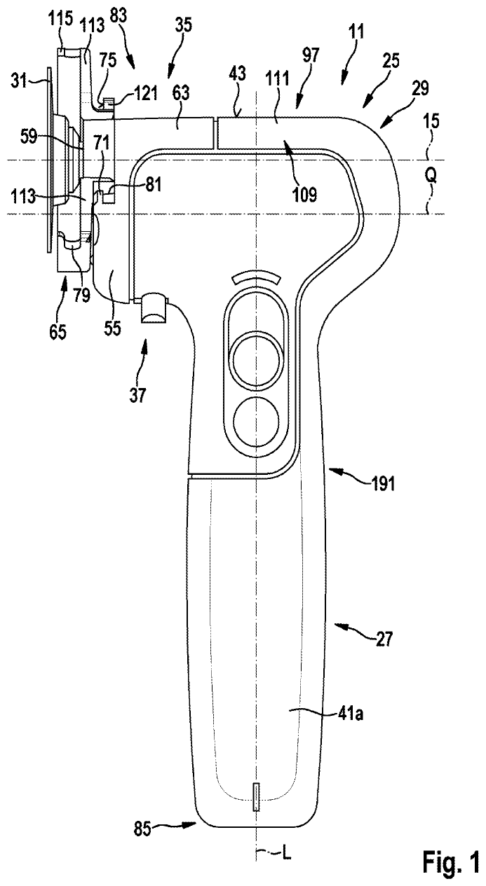

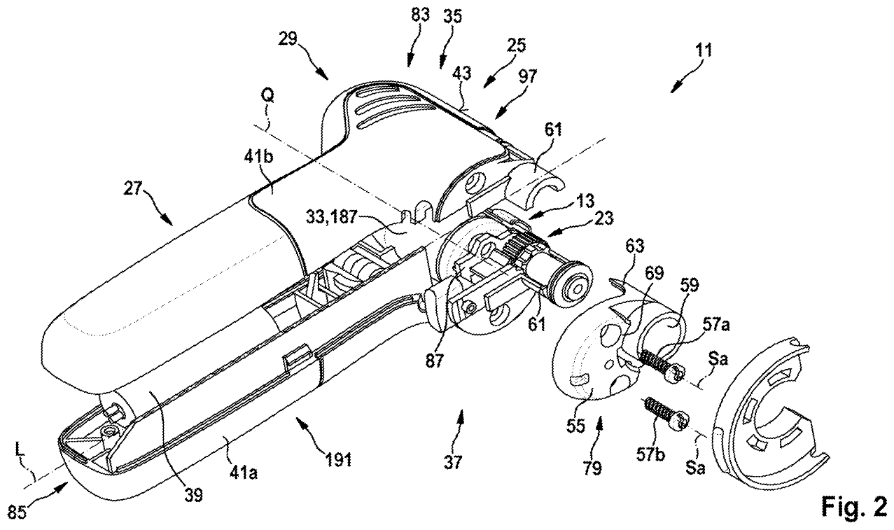

FIG. 1 shows a hand-held power tool 11 designed as an angle grinder with a drive unit 13, which is arranged differently from a “conventional” angle grinder 11, so that an output axis 15 is not arranged transversely, in particular at 90°, relative to an input axis 17 of the drive unit 13; instead, they are arranged substantially concentrically or parallel to one another. In the case of concentrically arranged axes, the output axis 15 and the input axis 17 substantially coincide during operation of the hand-held power tool 11. As a result, a direct drive can be realized in which an input shaft 19 directly drives the cutting disk 31 without the interposition of a gear unit 23. With axes arranged in parallel, the output axis 15 and the input axis 17 are arranged parallel to one another. In this case, an input shaft 19 and an output shaft 21 arranged parallel to the input shaft 19 can preferably be provided and be coupled by means of a gear unit 23.

The hand-held power tool 11 can have a tool housing 25 with a handle casing 27 and a drive casing 29 arranged on the handle casing 27. The handle casing 27 is arranged perpendicular to the drive casing 29, and the intention is thus for the operator to hold the hand-held power tool with one hand. The tool housing 25 is T-shaped in that the drive casing 29 is arranged centrally or eccentrically on the handle casing 27. The drive casing 29 projects on both sides in the axial direction along the input axis relative to the handle casing 27. The T shape allows the hand-held power tool 11 to be gripped firmly. In addition, a safety distance is created between the cutting disk 31 and the hand or finger gripping around the hand-held power tool 11.

The drive casing 29 is provided for accommodating the drive unit 13. The drive unit 13 has an input shaft 19 mounted to be rotatable about an input axis 17 and an output shaft 21 mounted to be rotatable about an output axis 15. The output shaft 21 is provided for accommodating a cutting disk 31 and driving it in the circumferential direction U about the output axis 15.

The drive unit 13 has an electric motor 33 with a rotational speed in a range of more than 17,000 revolutions per minute. The electric motor 33 is electronically commutated (EC drive).

The cutting disk 31 is provided for cutting and/or grinding workpieces and can be used universally, which results in a suitability for machining workpieces made of cellulose, for example grass, brush or roots, wood, plastic or a composite. The cutting disk 31 is likewise also suitable for machining, for example, metal, rock or a composite.

The cutting disk 31 is provided for detachable accommodation on rotationally driven, commercially available hand-held power tools 11. The cutting disk 31 can be accommodated in a receptacle device of a hand-held power tool 11, preferably a hand-held power tool 11 with a rotational and/or translational movement on a workpiece to be machined, which device is already known to a person skilled in the art and is designed to accommodate the cutting disk 31.

The cutting disk 31 projects in the radial direction relative to the drive casing 29 on a side 35 of the hand-held power tool 11 facing away from the handle casing 27 and is set back, or does not project, in the radial direction relative to the drive casing 29 on a side 37 of the hand-held power tool 11 facing the handle casing 27, as a result of which particularly secure and reliable handling of the hand-held power tool 11 is made possible.

The tool housing 25 has two housing half-shells 41a, 41b, which are connected to one another along a connecting plane Ve. Each housing half-shell 41a, 41b has a handle casing portion 27a and a drive casing portion 29a, wherein the two housing portions 27a, 29a of a housing half-shell 41a, 41b are integrally formed and merge into one another. The handle casing 27 is arranged on the drive casing 29. The handle casing 27 is delimited by the drive casing 29. The drive casing 29 is arranged substantially perpendicular to the handle casing 27.

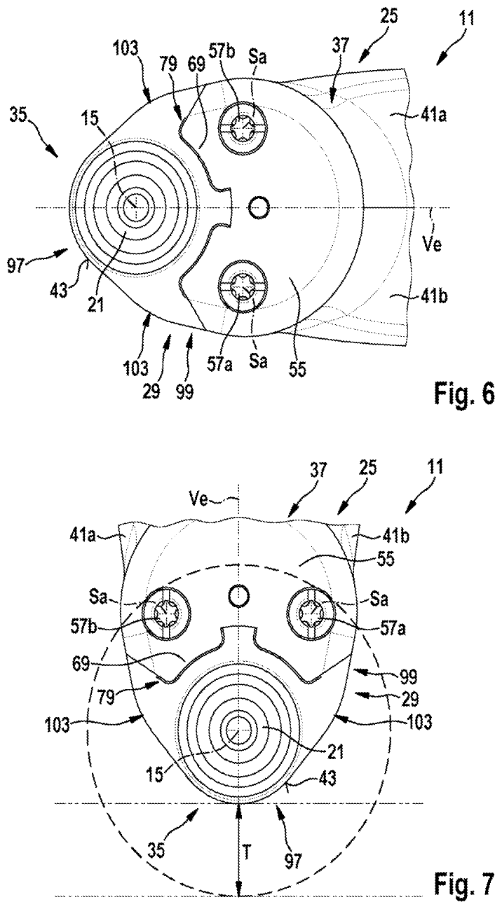

The drive casing 29 is substantially hollow-cylindrical and extends substantially along the output axis 15 and the input axis 17. In a section running substantially perpendicular to the input axis 17 or a side view (FIGS. 6 to 10), the drive casing 29 is substantially elliptical in shape in order to accommodate the input shaft 19 and the output shaft 21 parallel to one another. The output shaft 21 is arranged eccentrically on the tool housing 25 in order to maximize a cutting depth T of the cutting disk 31. For this purpose, the output axis 15 is arranged in the radial direction on a drive casing 29 limiting the cutting depth T in such a way that the cutting disk 31 projects from the tool housing 25 on a first side 35 and does not project from the tool housing 25 on a second side 37 facing away from the first side 35.

The hand-held power tool 11 has a rechargeable battery unit 39 or battery unit 39. The battery unit 39 is designed as a power source for supplying the hand-held power tool 11 with electrical power. The battery unit 39 is arranged in the handle casing 27 and surrounded by the handle casing 27. The battery unit 39 is arranged in a fixed or non-removable manner in the tool housing 25, and removal of the battery unit 39 is conceivable by disassembling the tool housing 25.

The battery unit 39 extends along an axis which coincides with a longitudinal axis L of the tool housing 25 or of the handle casing 27. The drive unit 13 extends along an axis which coincides with a transverse axis Q of the tool housing 25 or of the drive casing 29. The longitudinal axis L is arranged at an angle of up to a tolerance deviation of exactly 90° relative to the transverse axis Q by (FIG. 1, 2).

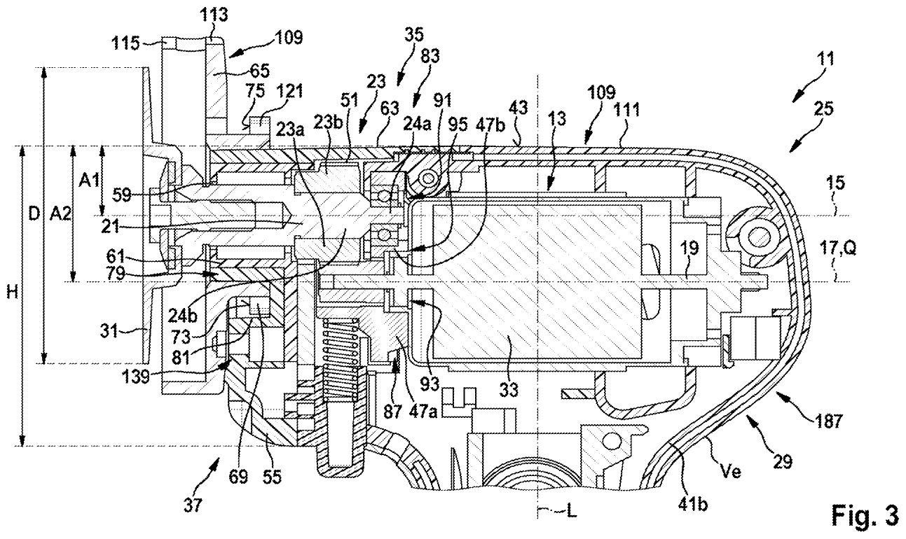

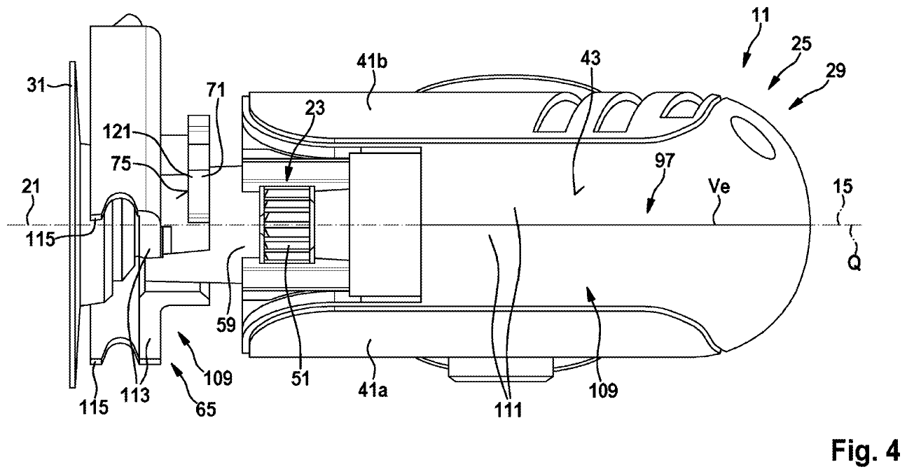

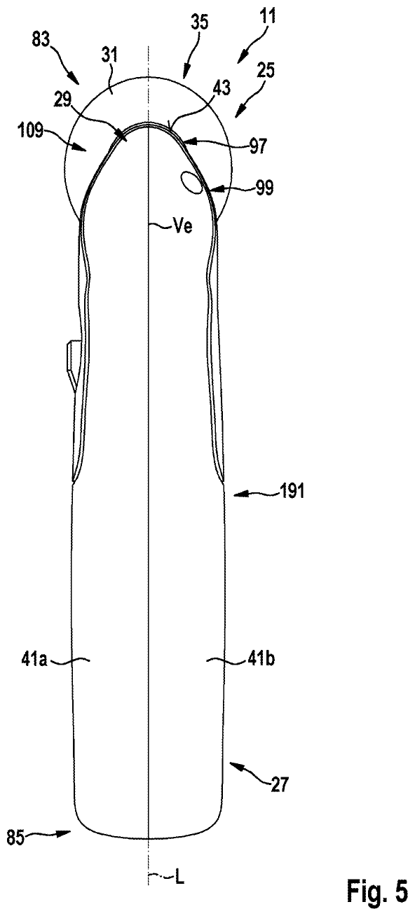

The tool housing 25 has a bearing region 99 with a bearing surface 43 for resting on a workpiece to be machined, wherein the bearing surface 43 is arranged closer to the output axis 15 than to the input axis 17. In particular, the output axis 15 of the output shaft 21 has a first distance A1 relative to a bearing surface 43 of the tool housing 25, and the input axis 17 of the input shaft 19 has a second distance A2 relative to the bearing surface 43 of the tool housing 25, the second distance being more than 180% greater and less than 250% smaller than the first distance (FIG. 3; in a section through the connecting plane Ve). The second distance A2 can be approximately 200% relative to the first distance A1. The second distance A2 is greater than the first distance A1. The output axis 15 and the input axis 17 are arranged parallel to one another and preferably lie in a plane or the connecting plane Ve. In order to maximize a cutting depth T of the accessory device 31, the output shaft 21 is arranged directly adjacent and preferably parallel to the bearing surface 43 of the tool housing 25. The output shaft 21 is arranged at least in the connecting plane Ve between the input shaft 19 and the bearing surface 43 of the tool housing 25. The output shaft 21 is arranged parallel to the input shaft 19 and is radially spaced apart from the input shaft 19. The output shaft 21 is arranged on a side 35 of the input shaft 19 facing away from the handle casing 27.

The bearing surface 43 extends in the axial direction along the output axis 15 and in the circumferential direction U around the output axis 15 along the drive casing 29. The bearing surface 43 is formed on an end face of the tool housing 25 and is provided as a contact surface of the hand-held power tool 11 for contacting a workpiece to be machined, which preferably contacts the workpiece during a machining operation. The bearing surface 43 limits a maximum extension of the drive casing 29. The bearing surface 43 extends on an outer side of the tool housing 25 around the output axis 15. The bearing surface 43 limits a maximum cutting depth T. The bearing surface 43 is arranged in a kind of “slipstream” of the accessory device when viewed in the axial direction along the output axis 15. The accessory device 31 covers the bearing surface 43 in the axial direction along the output axis 15. The bearing surface 43 is flat in portions and curved in portions. In particular in the circumferential direction U around the output axis 15, the bearing surface 43 is curved in portions and is flat in portions. The drive casing 29 can have two flat bearing surfaces 43 in the circumferential direction U which delimit at least one curved bearing surface 43.

The drive casing 29 has a height H in a plane extending parallel to the input axis 17 and the output axis 15, or the connecting plane Ve, and the output axis 15 has a distance A1 relative to the bearing surface 43, wherein the height H of the drive casing 29 is more than 200% and less than 250% greater than the distance (FIG. 3). The drive casing 29 has a height H in a plane extending parallel to the input axis 17 and the output axis 15, or the connecting plane Ve, and the accessory device 31 has a maximum diameter D, wherein the height H of the drive casing 29 is greater than the diameter D of the accessory device 31.

The hand-held power tool 11 has a gear unit 23, which is provided to connect the output shaft 21 to the input shaft 19. The gear unit 23 is designed as a spur gear unit 23 and has a gear ratio of approximately 3. The output shaft 21 has a spur gear element 23b with a diameter which is larger than a spur gear element 23a of the input shaft 19. The spur gear element 23b of the output shaft 21 extends in the radial direction at least in portions through the housing half-shells 41a, 41b.

The output axis 15 of the output shaft 21 is spaced apart in the radial direction with respect to the input axis 17 such that the output axis 15 or an extension of the output axis 15 intersects the electric motor 33 of the drive unit 13 or a stator of the electric motor 33. The output shaft 21 is arranged parallel to the input shaft 19 or is spaced apart therefrom such that the output axis 15 is arranged or runs between the input axis 17 and a maximum radial extension of the electric motor 33, in particular the stator of the electric motor 33.

The output shaft 21 projects in the radial direction in portions relative to a maximum extension of the drive unit 13. The spur gear element 23b of the output shaft 21 projects in the radial direction relative to the input axis 17, in portions relative to the electric motor and the drive unit 13. The output shaft 21 extends in the radial direction in such a way that a plane formed by a maximum radial extension of the drive unit 13 lies between a plane formed by the output axis 15 and a plane formed by the maximum radial extension of the output axis 15. The planes are arranged parallel to one another. The output shaft 21 has a first bearing portion 24a, which is provided for accommodating a bearing element, and a second bearing portion 24b, which is provided for accommodating the spur gear element 23b. The first bearing portion 24a has a first diameter, and the second bearing portion 24b has a second diameter, the second diameter being greater than the first diameter. The second bearing portion 24b projects at least in portions in the radial direction relative to the drive unit 13.

The housing half-shells 41a, 41b have a recess 51, which is provided to at least partially accommodate a spur gear element 23b of the output shaft 21. The housing half-shells 41a, 41b delimit the recess 51 or surround it by 360° in one plane. The recess 51 extends in the circumferential direction U around the output axis 15 from a first housing half-shell 41a to a second housing half-shell 41b. The recess 51 is arranged on the connecting plane Ve of the first housing half-shell 41a and the second housing half-shell 41b. The spur gear element 23b extends at least in portions through the recess 51 or into the recess 51. The recess 51 can form an inspection opening for servicing the hand-held power tool 11. The recess 51 is provided to create a cavity in order to accommodate the spur gear element 23b and to arrange the output shaft 21 as close as possible to the bearing surface 43, in particular to increase a cutting depth T. The recess 51 is arranged on a side 35 facing away in front of the handle casing 27 or on a cutting side of the drive casing 29.

The spur gear element 23b projects at least in portions in the radial direction relative to the recess 51 and/or the housing half-shells 41a, 41b forming the tool housing 25.

The tool housing 25 has a bearing housing 55, which is provided to at least partially surround the housing half-shells 41a, 41b. The bearing housing 55 is provided to hold the housing half-shells 41a, 41b together and to position them or to fix them relative to each other. The bearing housing 55 is connected by means of two screw connections 57a, 57b to the first housing half-shell 41a and to the second housing half-shell 41b. The screw connections 57a, 57b each have screw axes Sa which are arranged parallel to the output axis 15 and to the input axis 17. The screw axes Sa are connected, parallel to a connecting plane Ve that separates the housing half-shells 41a, 41b, to the housing half-shells 41a, 41b by means of the screw connections 57a, 57b. A screw connection 57a, 57b is provided in each case, which connects the bearing housing 55 to a housing half-shell 41a, 41b in each case.

The bearing housing 55 has a substantially hollow-cylindrical bearing receptacle and the housing half-shells 41a, 41b form a substantially hollow-cylindrical housing portion, wherein the bearing receptacle is provided for accommodating the housing portion of the housing half-shells 41a, 41b and to secure them in the radial direction in a form-fitting manner. The substantially hollow-cylindrical housing portions are provided to surround the output shaft 21.

The bearing housing 55 or the bearing receptacle is provided to surround the housing portion of the housing half-shells 41a, 41b in a radial plane of the output axis 15 by 360°. In a connected state, the housing half-shells 41a, 41b or the housing portions form a housing opening 59 in the drive casing 29, which housing opening is delimited by the housing half-shells 41a, 41b. The housing opening 59 is at least substantially cylindrical and is provided for accommodating and preferably mounting the output shaft 21. The housing opening 59 is provided to guide the output shaft 21 out of the drive casing 29.

The two housing half-shells 41a, 41b form a housing wall 61 which delimits the housing opening 59 in the drive casing 29. The housing wall 61 is of hollow-cylindrical design and extends in the axial direction along the output axis 15. The housing wall 61 is formed from two substantially semi-hollow-cylindrical housing portions of the two housing half-shells 41a, 41b. The housing wall 61 extends axially along the output axis 15 and projects outward on the tool housing 25.

The bearing housing 55 covers the housing half-shells 41a, 41b in an axial direction along the output axis 15 by at least 10%, in particular at least 20%, preferably at least 30%, preferably at least 40%. The bearing housing 55 is provided to at least partially surround the housing wall 61 and the housing half-shells 41a, 41b.

The bearing housing 55 is provided to form-fittingly hold or hold together the housing half-shells 41a, 41b in the radial direction relative to the output axis 15 and to position or fix them relative to each other. The bearing housing 55 is connected to the first housing half-shell 41a and to the second housing half-shell 41b by means of a screw connection 57a, 57b in the axial direction parallel to the output axis 15. The screw connection 57a, 57b has a screw axis Sa which is formed parallel to the output axis 15 and to the input axis 17.

The bearing housing 55 is provided to cover the recess 51 and the spur gear unit 23 or the spur gear element 23b. The recess 51 is completely covered by the bearing housing 55, as a result of which the cutting depth T can be further optimized. To cover the recess 51, the bearing housing 55 has a housing extension 63. The housing extension 63 extends in the axial direction along the output axis and along a connecting plane Ve of the two housing half-shells 41a, 41b. The housing extension 63 is provided to cover the recess 51 in such a way that the spur gear element 23b arranged in the recess 51 is protected against accidental access by an operator. The housing extension 63 can form a bearing surface for supporting the hand-held power tool 11, which bearing surface is set back in portions, preferably completely, relative to the bearing surface 43 of the housing half-shell or the housing half-shells.

The drive casing 29 is double-walled in the region of the output shaft 21. The drive casing 29 is double-walled in a tool housing portion in which the output axis 15 exits from the tool housing 25. The tool housing 25 is double-walled in a portion in which the half-shell housing is covered by the bearing housing 55. The double-walled tool housing portion 25 extends in the axial direction along the output axis 15 and surrounds it. A first wall is formed by the housing wall 61 of the tool housing 25 or the two housing half-shells 41a, 41b. A second wall is formed by the bearing receptacle of the bearing housing 55. The bearing receptacle is arranged coaxially around the housing wall 61.

The tool housing 25 has a single-wall design on a side of the drive casing 29 facing away from the double-walled tool housing portion in the axial direction, in the region of the recess 51.

The bearing housing 55 has a form-fit element 69 which is provided to hold a guard device 65 in the axial direction along the output axis 15 in a form-fitting manner on the bearing housing 55. The form-fit element 69 extends in the radial direction toward the output axis 15. The form-fit element 69 is designed to be partially circular in relation to the output axis and limits an extension of the bearing housing 55 in the axial direction along the output axis 15. The form-fit element 69, 71 has a form-fit surface 73 which contacts the guard device 65 in order to hold the guard device 65 in a form-fitting manner on the bearing housing 55. The form-fit surface 73 has a surface normal which is oriented in a direction facing the hand-held power tool 11. The form-fit element 69 is provided to delimit the bearing housing 55.

The bearing housing 55 has a guide device 79 which is provided for accommodating a guard device 65 and mounting it to be movable about the output axis 15. The guide device 79 extends in the circumferential direction U around the output axis 15. The guide device 79 has a guide recess 81 which extends in the axial direction along the output axis into the tool housing 25 and then in the radial direction relative to the output axis 15. The guide recess 81 is L-shaped in a connecting plane Ve. The guide recess 81 is provided for accommodating a form-fit element 71 of the guard device 65 and to be delimited by the form-fit element 69. The guide recess 81 is formed by the form-fit element 69.

The input shaft 19 is mounted in a floating manner and has a fixed or mounted end 83 and a free or loose end 85 remote from the fixed or mounted end 83. The tool housing 25 has no support structure which supports the input shaft 19 on a side of the input shaft 19 facing away from the gear unit 25. The spur gear element 23b is arranged at the loose end 85. The spur gear element 23b projects in the axial direction along the input axis relative to the input shaft 19.

The hand-held power tool 11 has a bearing unit 87, which is provided to mount the output shaft 21 relative to the input shaft 19. The bearing unit 87 is connected in a rotationally fixed manner to a motor housing 187 of the electric motor 33. The bearing unit 87 is form-fittingly connected to the electric motor 33 by means of a screw connection. The bearing unit 87 has a first bearing point 91, which is provided to mount the output shaft 21. The first bearing point 91 is provided for accommodating a bearing element designed as a roller bearing element. The bearing unit 87 has a second bearing point 93, which is provided for directly or indirectly mounting the input shaft 19. The second bearing point 93 is provided for accommodating a bearing element of the input shaft 19 designed as a roller bearing element, or the motor housing 187 of the electric motor 33s. The bearing unit 87 is connected in a form-fitting manner to the motor housing 187 of the electric motor 33. The motor housing 187 of the drive unit 13 has a tubular bearing lobe 95 which extends in the axial direction and delimit the motor housing 187. The bearing lobe 95 is provided for accommodating and surrounding the input shaft 19. The bearing lobe 95 is provided for accommodating a bearing element designed as a roller bearing element and for mounting it around the input axis 17. The second bearing point 93 accommodates the bearing lobe 95 and connects it in a form-fitting manner in the radial direction. The bearing lobe 95 is provided on the one hand to accommodate in an inner region the bearing element for mounting the input axis 17 and to be accommodated in an outer region by the second bearing point 93.

The motor housing 187 further comprises two connecting means designed as a connection thread, which are provided to connect the bearing unit 87 to the motor housing 187 by means of a screw connection.

A section through the bearing unit 87 running perpendicular to the output axis 15 intersects the bearing element of the output axis 15 and the bearing element of the input axis 17. The first and the second bearing point 91, 93 are arranged parallel to one another. The bearing unit 87 separates the first bearing point 91 from the second bearing point 93.

The tool housing 25 can be designed in such a way that a maximum cutting depth T of the hand-held power tool 11 to be achieved is adjustable depending on an angular position alpha of the hand-held power tool 11 relative to a workpiece to be machined. The angular position alpha is to be understood here as a position of the hand-held power tool which results from a movement of the hand-held power tool about the output axis or in a cutting plane.

A maximum cutting depth T to be achieved can be controlled by means of a rotational movement of the hand-held power tool 11 or the tool housing 25 of the hand-held power tool 11 relative to the workpiece. A rotation of the hand-held power tool 11 about the input axis 17 or about an output axis 15 is considered as a rotational movement. A rolling movement can be regarded as a rotational movement, in which the hand-held power tool 11 rolls on a bearing surface 43 of the housing half-shell(s) 41a, 41b approximately about the input axis 17 or the output axis 15. The rotational movement of the hand-held power tool 11 can change an angular position alpha of the hand-held power tool 11 in the circumferential direction U around the output axis 15 relative to the workpiece to be machined, as a result of which the maximum cutting depth T can be changed. Depending on the changed angular position alpha, an angle of the hand-held power tool 11 relative to the workpiece changes, as a result of which a cutting depth T is limited, maintained or released.

For example, in the case of a first angular position alpha of the hand-held power tool 11, a first maximum cutting depth T can be achieved and, in the case of a second angular position alpha of the hand-held power tool 11, a second maximum cutting depth T can be achieved, wherein the first cutting depth T is greater than the second cutting depth T (FIGS. 6 to 10).

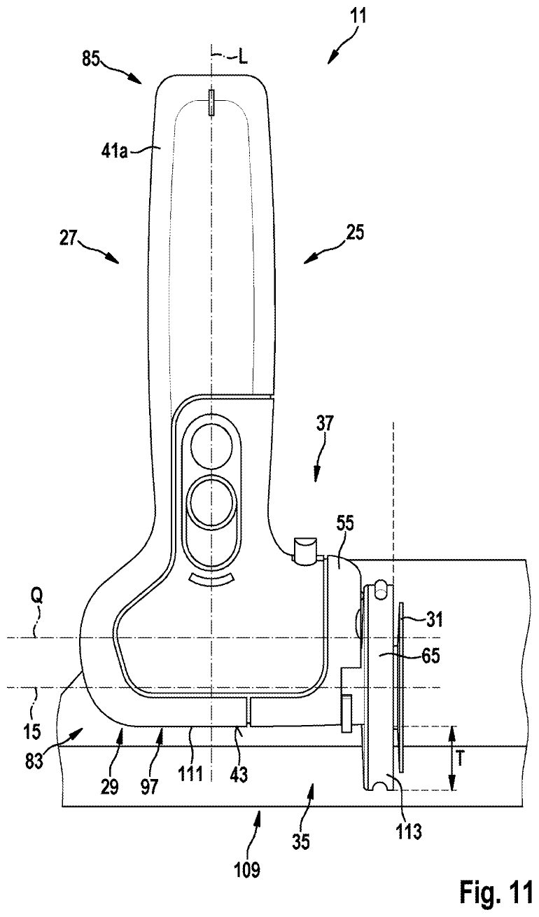

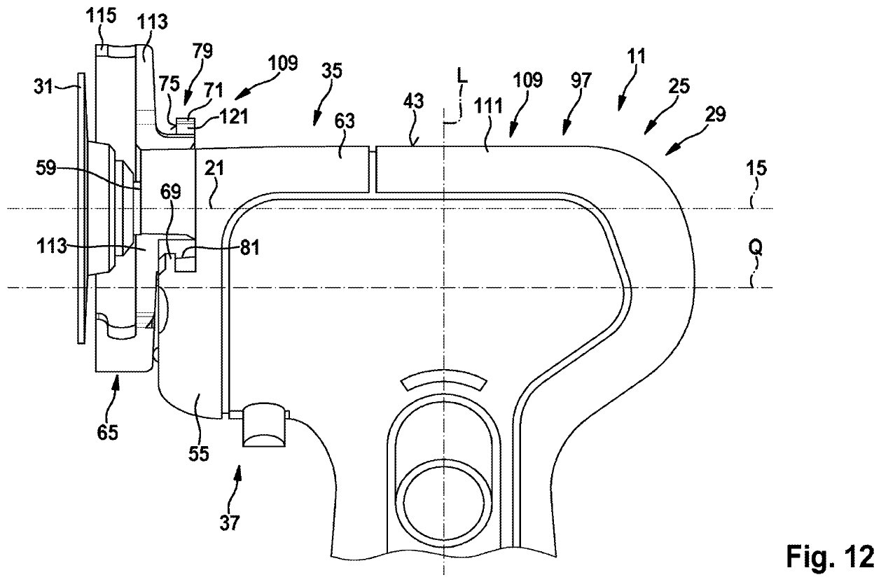

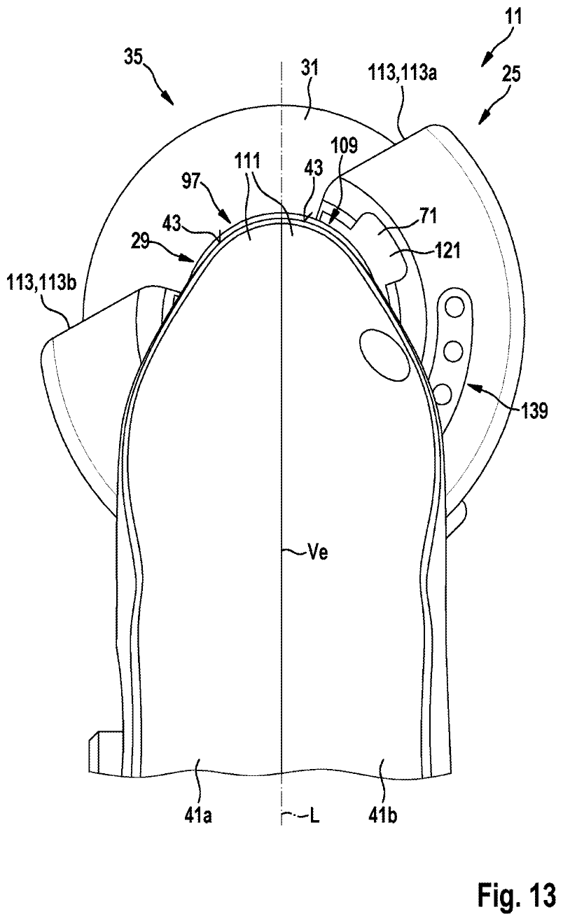

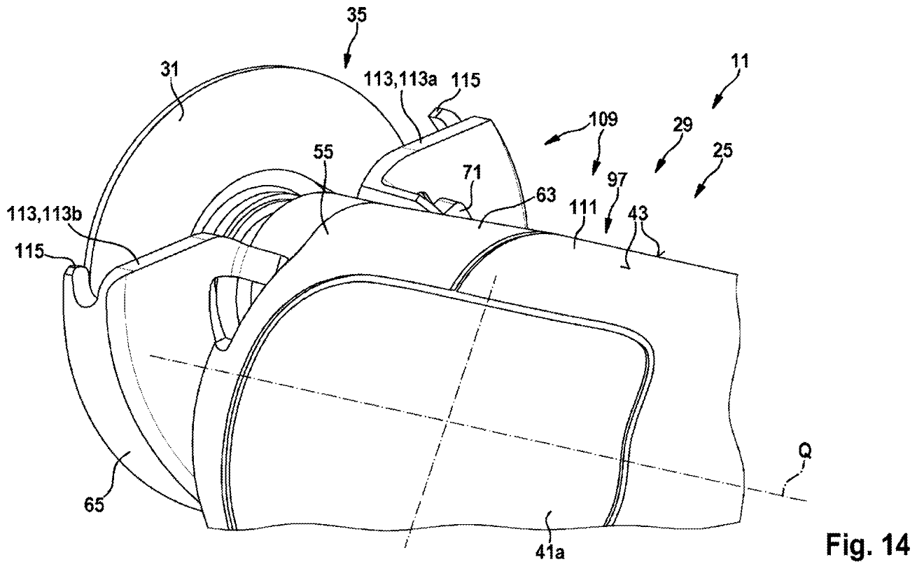

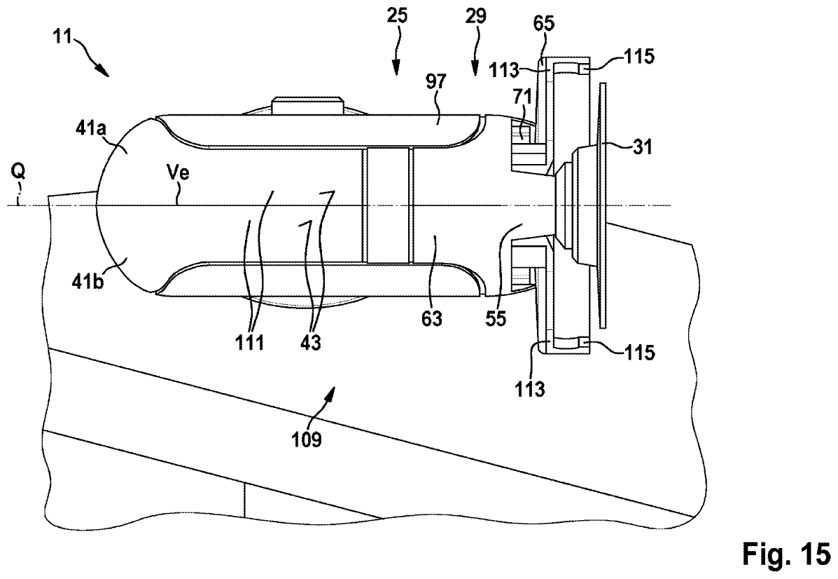

For example, the first maximum cutting depth T can be achieved by the hand-held power tool 11 being provided in a first angular position alpha in which the hand-held power tool 11 is arranged perpendicular to a workpiece surface and assumes an angle of approximately 90° or an angle range of 90° to 40°. In this case, a maximum cutting depth T of approximately 14 mm can be achieved (FIGS. 7 to 8, FIG. 11).

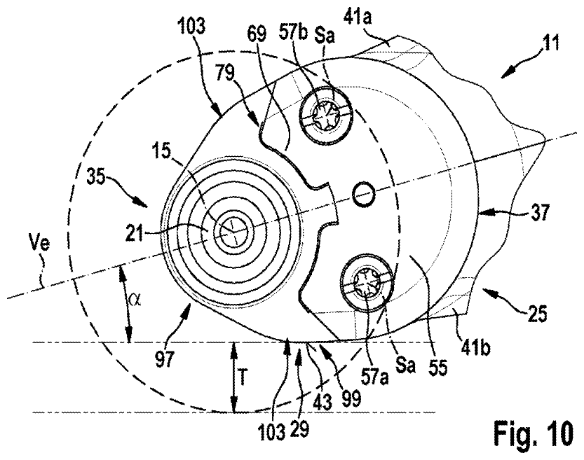

For example, the second maximum cutting depth T can be achieved by the hand-held power tool 11 being provided in a second angular position alpha in which the hand-held power tool 11 is arranged transversely to the workpiece surface and assumes an angle of approximately 30° or an angle range of less than 30° and in particular 30° to 15°. In this case, a maximum cutting depth T of approximately at most 12.4 or at most 10 mm can be achieved (FIG. 9, FIG. 10).

The tool housing 25 is designed such that a plurality of angular positions alpha can be assumed by means of a rotational movement of the tool housing 25 about the output axis relative to a workpiece. The tool housing 25 is designed such that the cutting depth T can be controlled by means of a rotational movement of the tool housing 25 about the output axis 15 relative to a workpiece.

The tool housing 25 has a first bearing region 97 and a second bearing region 99, wherein the bearing regions 97, 99 each define a distance of the bearing regions 97, 99 from the output axis 15. The bearing regions 97, 99 are designed as bearing edge portions or as bearing surface portions. The bearing regions 97, 99, in particular the bearing surface portions, have a flat design. The first bearing region 97 is spaced apart from the second bearing region 99.

The first bearing region 97 is designed as a flat first bearing surface 43 which extends at least substantially tangentially to a bearing region 97, 99 of the tool housing 25 that defines the maximum cutting depth T.

The first bearing region 97 has a first curved bearing region portion 97a and a second flat bearing region portion 97b. The first bearing region portion 97a adjoins the second bearing region portion 97b in the circumferential direction U around the tool housing 25. The first bearing region portion 97a and the second bearing region portion 97a are provided to space the hand-held power tool 11 apart from the workpiece in such a way that the same or a constant maximum cutting depth T is achieved. The first bearing region portion 97a has a first bearing point with a first distance from the output axis 15. The second bearing region portion 97b has a second bearing point with a second distance from the output axis 15. The first bearing point is arranged at a distance from the second bearing point in the circumferential direction U around the output axis 15. In particular, the second distance is greater than the first distance. The first bearing region portion 97a and the second bearing region portion 97b each have a bearing point which has the same distance from the output axis 15. This bearing point can preferably be formed by a connection point of the first bearing region portion 97a and the second bearing region portion 97b. The first bearing region portion 97a has a plurality of bearing points which are spaced apart from one another in the circumferential direction U around the output axis 15 and have the same distance from the output axis 15. The second bearing region portion 97b has a plurality of bearing points which are spaced apart from one another and are of different sizes.

The second bearing region 99 is designed as a flat second bearing surface 99a, wherein the second bearing region portion 97b of the first bearing region 97 is angled relative to the second bearing region 99, the second bearing region portion 97b and the second bearing region 99 being flat.

The second bearing region 99 has a plurality of bearing points spaced apart from one another, which each have distances to the output axis 15 that are of different sizes in relation to one another. In other words, the spaced apart bearing points of the second bearing region 99 are at different distances from the output axis 15.

The tool housing 25 is substantially symmetrical so that at least a further first and further second bearing region 99 is arranged on a side of the tool housing 25 facing away from the first and the second bearing region 97. A plane of symmetry is formed by a plane running parallel to the output axis 15 and the input axis 17 and/or a connecting plane Ve of the housing half-shells 41a, 41b.

The accessory device 31 substantially covers the second bearing region 99 in the axial direction with respect to the output axis 15. A plane delimiting the accessory device 31 in the radial direction and extending in the axial direction with respect to the output axis 15 intersects the second bearing region 99.

The tool housing 25 has an intermediate bearing region 103 with an in particular curved intermediate bearing edge and/or intermediate bearing surface, which is arranged between the first bearing region 97 and the second bearing region 99. The intermediate bearing region 103 is designed as a lobe 103.

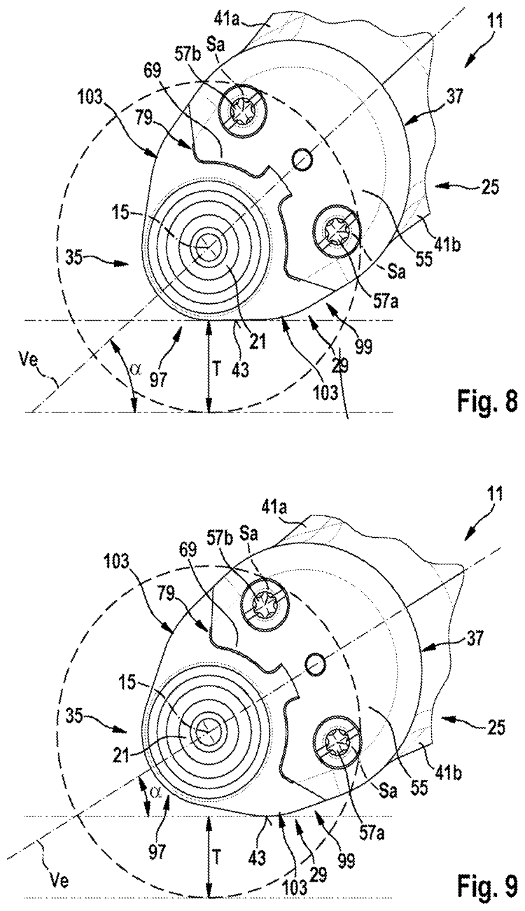

The tool housing 25 is designed such that a first maximum cutting depth T can be achieved in an angle range of up to 140°, in particular of 120°, preferably of 100°. For example, this can be achieved by resting the tool housing 25 on the first bearing region 97. As can be seen in FIG. 7 and FIG. 8, an angular range can tilt from an angular position alpha of the hand-held power tool 11 of 90° to an angular position alpha of 40°, that is to say by up to 60°, and maintain a first maximum cutting depth T, such as 14 mm. Taking into account the symmetry, it is possible to infer an angular range of 120° in which the first maximum cutting depth T (14 mm) can be achieved.

As can also be seen in the figures, an angle range can tilt from a further angular position alpha of the hand-held power tool 11 of 40° to an angular position of 30° or 15°, i.e., by up to 10° or 25°, and maintain a further maximum cutting depth T, such as 12.4 mm or 9.795 mm.

The bearing regions 97, 99 are preferably not located on the bearing housing but on the housing half-shells of the tool housing or the drive casing. Accordingly, the bearing regions 97, 99 of the housing half-shells project in the radial direction relative to the output axis at least in portions relative to the bearing housing.

The hand-held power tool 11 has a support device 109, in particular formed by the tool housing 25, which is intended to support the hand-held power tool 11 while in an operating state.

The support device 109 is provided to keep the hand-held power tool 11 at a predetermined cutting angle position beta while in an operating state. By means of the support device 109, a vertical cut (cutting angle position beta of 90°) is to be achieved in particular in which the accessory device 31, in particular a side surface of the accessory device 31, is oriented perpendicular to a surface of the workpiece to be machined and is held in this orientation by means of the support device 109. This vertical cut is to be maintained during a guidance of the hand-held power tool 11 along a cutting direction or along the surface of the workpiece to be machined.

The support device 109 is provided to limit a maximum cutting depth T of the accessory device 31. The support device 109 forms a cutting depth stop.

The support device 109 has a support element 111 which is arranged on the tool housing and is intended to form a support plane for supporting the hand-held power tool 11 on a workpiece to be machined. The support element 111 is designed as a support surface and preferably forms a surface contact with the workpiece to be machined. It is clear that the support surface may alternatively or additionally form a point contact or a line contact with the workpiece to be machined. The present support surface is intended to form a surface contact with the workpiece. It is clear that the support device 109 can have a single number or a plurality of support surfaces or support points or support lines. The support surface can be provided to form a bearing contact of the bearing surface 43 of the tool housing 25 against the workpiece.

The support device 109 has a first support element 111 designed as a support surface, which is arranged on the housing half-shell 41a, 41b. The first support surface is formed integrally with the housing half-shell 41a, 41b. The support surface delimits an extension of the housing half-shell 41a, 41b. The support surface is preferably formed by the first bearing region 97, 99 or the bearing surface 43. The support surface is formed by the bearing surface 43 of the first bearing region portion 97a and the second bearing region portion 97b of the first bearing region 97. Similarly to the first bearing region 97, the support surface extends in the circumferential direction U around the output axis 15 of the drive casing 29. Similarly to the first bearing region portion 97a, the support surface has a first support surface portion which is curved, in particular curved around the output axis 15. Similarly to the second bearing region portion 97b, the support surface has a second support surface portion, which is flat.

The support surface extends parallel to the output axis 15 along the output axis 15. The support surface extends orthogonally to the accessory device 31 or to a cutting plane of the accessory device 31.

The support surface is arranged on a side of the tool housing 25 of the hand-held power tool 11 facing away from the accessory device 31. The support surface extends in a range of at least 40% up to a maximum of 60% relative to a maximum extension of the drive casing parallel to the output axis 15. The maximum extension of the drive casing parallel to the output axis 15 has a first end 83 facing the accessory device 31 and a second end 85 remote from the first end 83, the support surface being arranged at the second end 85 of the drive casing 29. The support surface can preferably be spaced apart from the cutting disk 31 and from the first end 83. The support element 111 is arranged on the drive casing 29.

A support plane formed by the support element 111 is arranged parallel to the output axis 15 in order to enable a vertical cut into the workpiece.

To produce a vertical cut, a support plane formed by the support elements 111 is arranged parallel to the output axis 15.

The support element 111 extends parallel to the output axis 15 and is spaced apart from the output shaft 21 in the axial direction along the output axis 15. The support element 111 is arranged in the axial direction along the output axis 15 between a maximum extension of the input shaft 19, in particular between the bearing elements of the input shaft 19.

The support element 111 is arranged on a side 35 of the drive casing 29 facing away from the handle casing 27. A longitudinal axis L extending along the handle casing 27 intersects the first support element 111.

The hand-held power tool 11 has a guard device 65 and a support device 109 formed by the guard device 65, which is provided to support the hand-held power tool 11 in an operating state, as a result of which a tilting movement of the hand-held power tool 11 during an operating state or a cutting operation can be avoided.

The support device 109 has a further support element 113 which is arranged on the guard device 65 and is formed by the guard device 65 or is formed integrally with the guard device 65.

The second support element 113 is mounted to be rotatable relative to the first support element 111. The second support element 113 can be mounted in such a way that the second support element adapts to a support plane of the first support element by means of a rotational movement about the output axis.

The guard device 65 extends in the axial direction along the output axis 15 from a first side of the accessory device 31 to a second side of the accessory device 31 facing away from the first side. The guard device 65 surrounds the accessory device 31 in the axial direction along the output axis 15 and in the circumferential direction U around the output axis 15.

The guard device 65 has a second support element 113 which is arranged in relation to the accessory device 31 on a side of the accessory device 31 facing the tool housing 25. The guard device 65 has a third support element 115 which is arranged in relation to the accessory device 31 on a side of the accessory device 31 facing away from the tool housing 25. The second support element 113 and the third support element 115 limit an extension of the guard device 65 in the circumferential direction U around the output axis 15. The guard device has a first end 83 and a second end 85 opposite the first end 83 in the circumferential direction U around the output axis 15, a support element 113a, 113b being arranged on each of the two ends 83, 85. The two support elements 113a, 113b are arranged parallel to and spaced apart from one another. The two support elements 113a, 113b define a distance of the guard device 65 which is dimensioned such that the guard device 65 surrounds the drive casing 29 at least in portions.

The support elements 113a, 113b are designed as flat support surfaces. The support surfaces each have a surface normal which is oriented in a direction facing away from the output axis 15.

The support surface of the guard device 65 and of the tool housing 25 are arranged parallel to one another and define a support plane which is arranged substantially parallel to the output axis 15.

The guard device 65 is connected to the tool housing 25 or the bearing housing 55 in a form-fitting manner axially along the output axis 15 and radially in relation to the output axis 15 and is mounted to be movable in the circumferential direction U about the output axis 15 relative to the tool housing 25 or the bearing housing 55.

The hand-held power tool 11 has a guard device 65 with a form-fit element 71, which is provided to form a form-fitting connection with the bearing housing 55 of the tool housing 25.

The tool housing 25 has a guide device 79 designed as a guide recess 81, which is provided for accommodating the form-fit element 69 and for guiding it around the output axis 15. The guide recess 81 is L-shaped in cross section and extends in the axial direction along the output axis 15 into the tool housing 25 and then in the radial direction relative to the output axis 15. The guide device 79 extends in the shape of an arc in the circumferential direction U around the output axis 15.

The form-fit element 71 is designed as a shaped lobe 121 extending in the radial direction relative to the output axis 15 and extends in the radial direction toward the output axis 15. The shaped lobe 121 is partially circular in relation to the output axis 15 and limits an extension of the guard device 65 in the axial direction along the output axis 15. The shaped lobe 121 has a form-fit surface 75 which contacts the tool housing 25 in order to hold the guard device 65 in a form-fitting manner on the tool housing 25. The form-fit surface 75 has a surface normal which is oriented in a direction facing away from the hand-held power tool 11. The shaped lobe 121 is provided to encompass the tool housing 25 and to be guided with the guide device 79. The form-fit element 71 is provided to engage in the guide device 79 designed as a guide recess 81 or to be accommodated thereby. The form-fit surface 75 is supported on a side wall of the guide device 79 and forms therewith a form-fitting connection in the axial direction along the output axis 15. The form-fit surface 75 and the side wall extend perpendicular to the output axis 15.

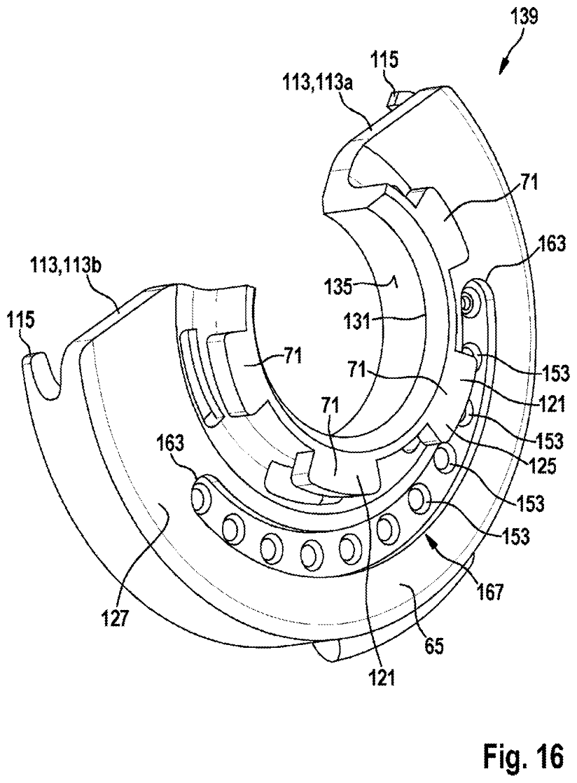

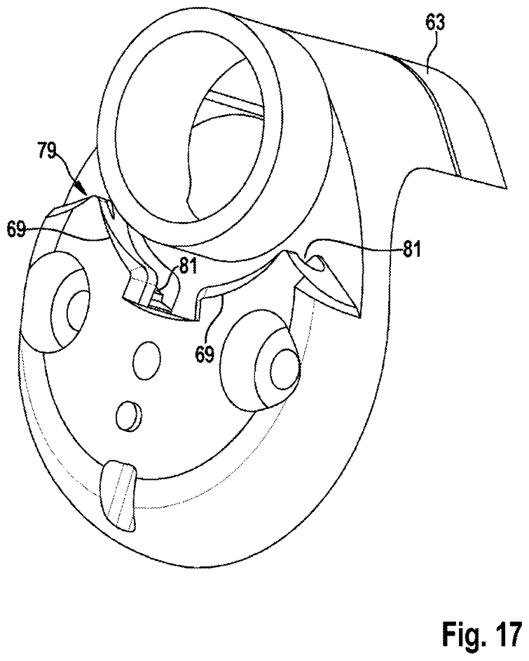

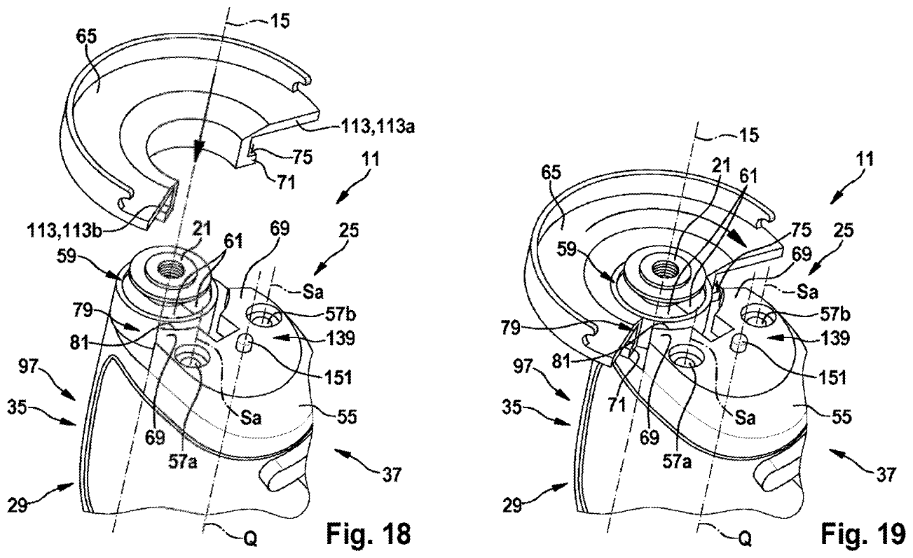

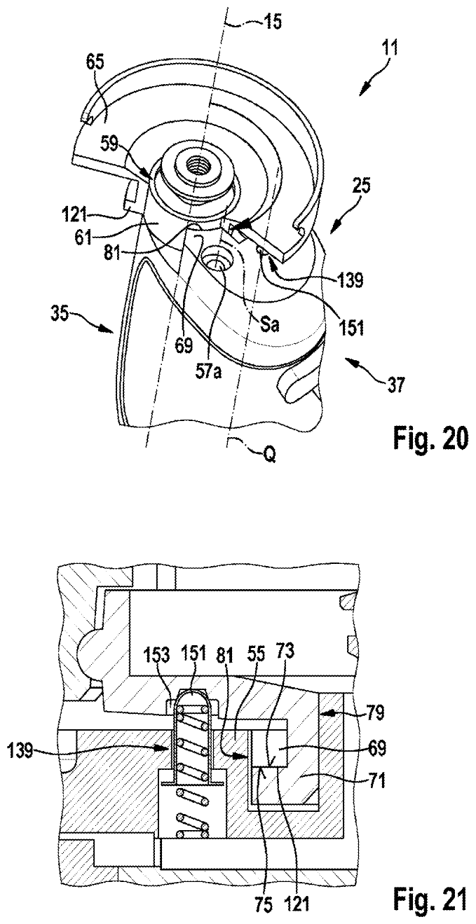

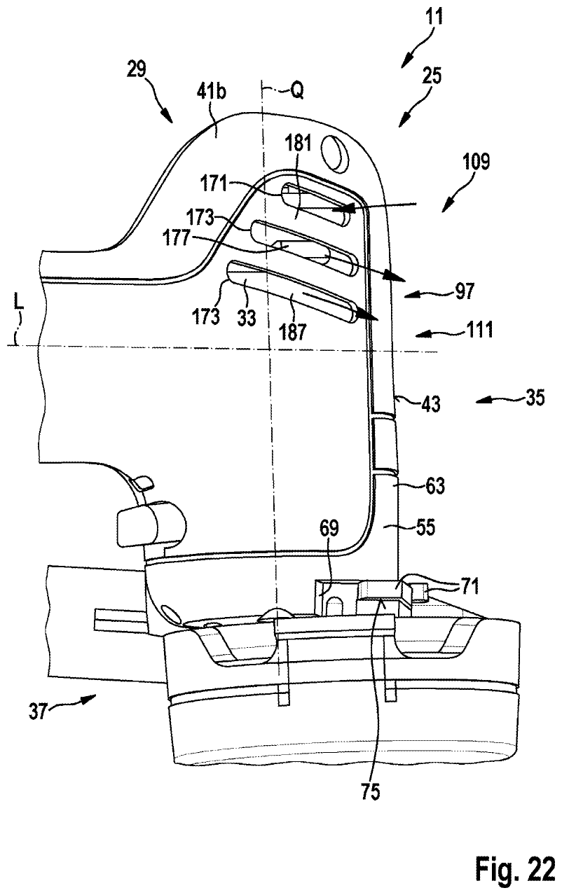

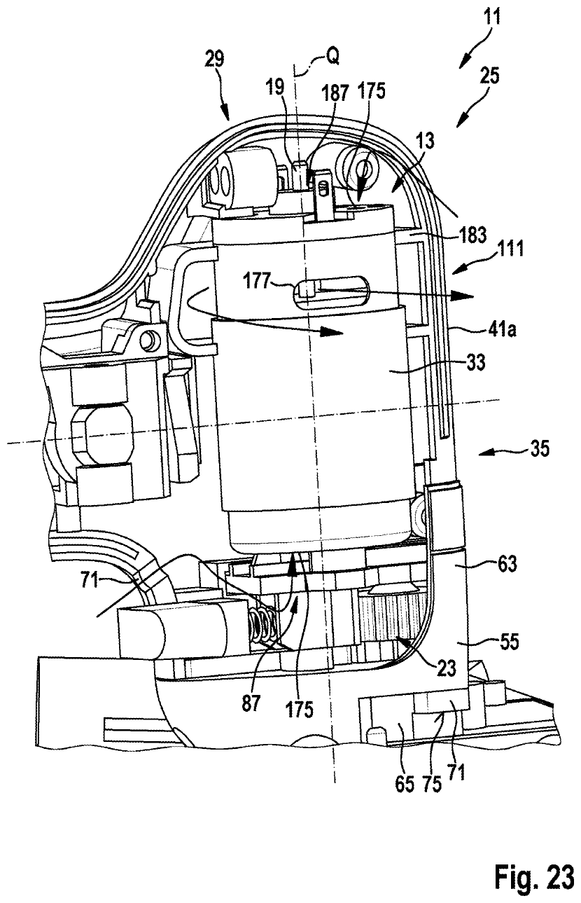

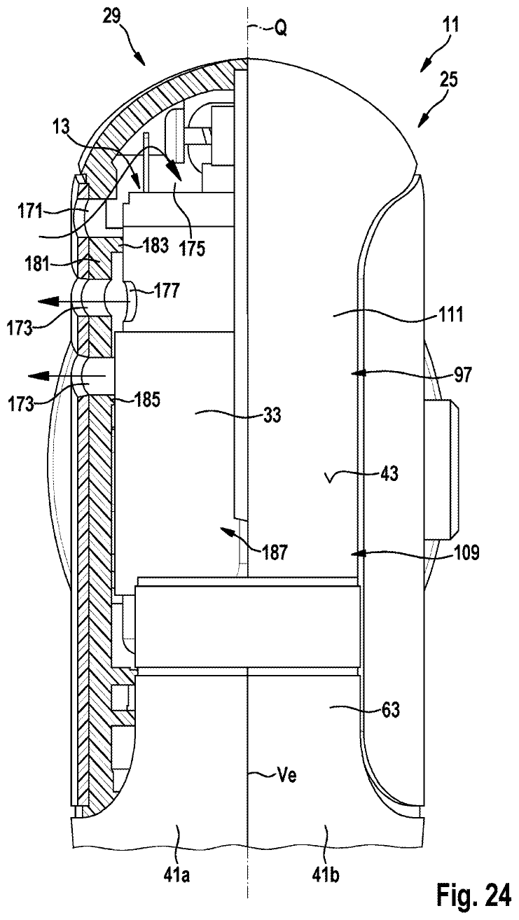

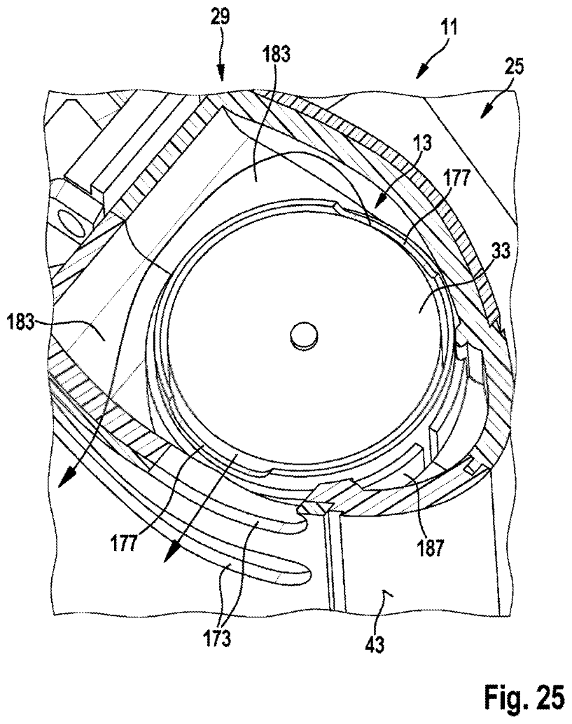

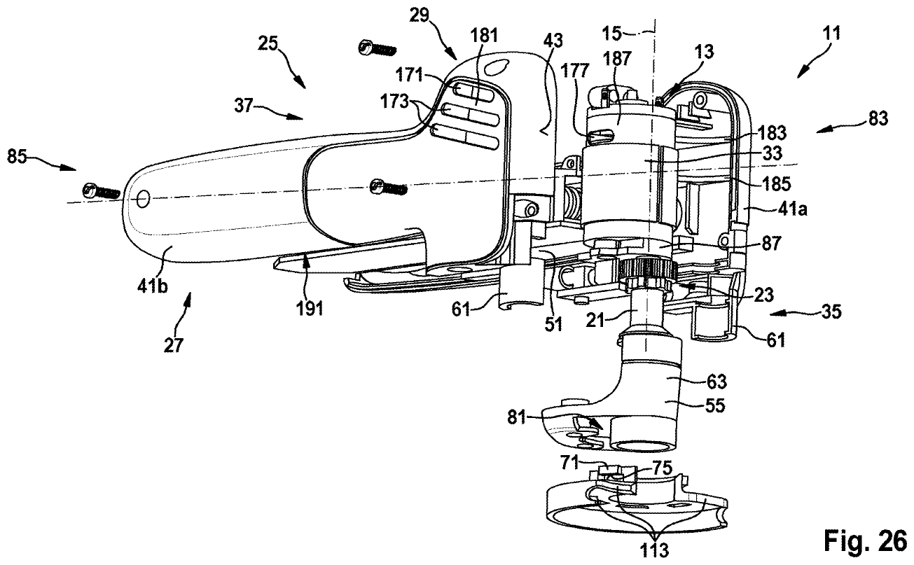

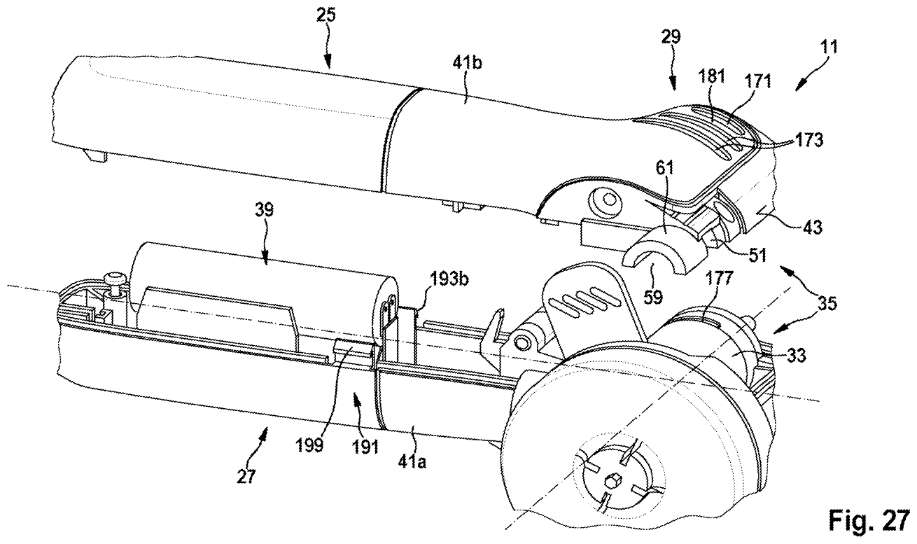

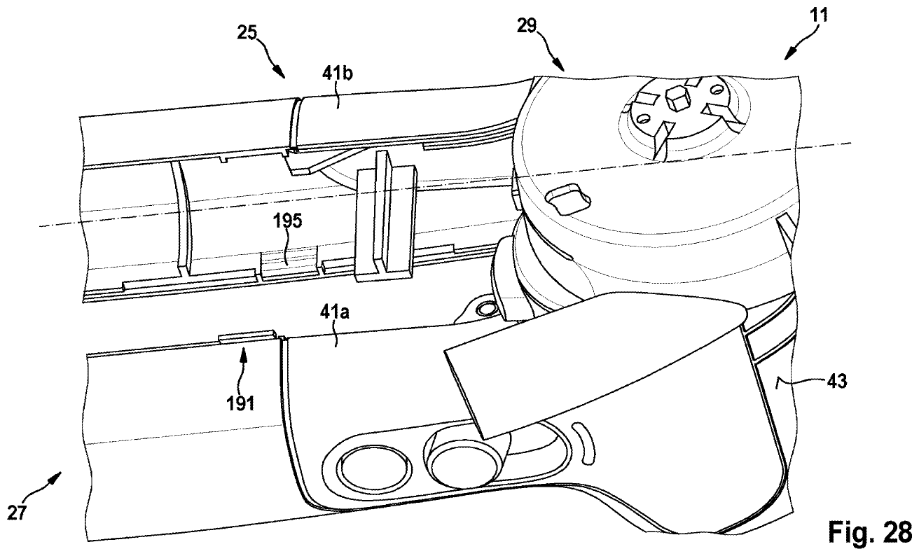

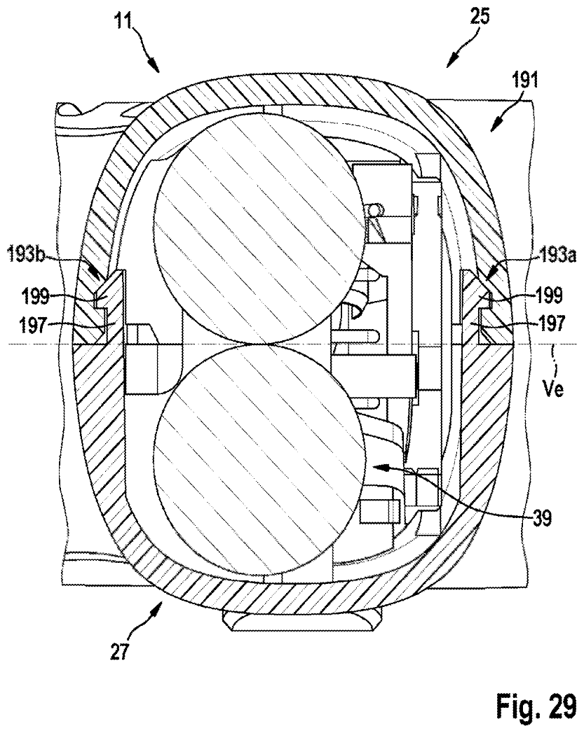

The guard device 65 has a further form-fit element 71 and, as shown in FIG. 16, a total of four form-fit elements 71, which are spaced apart from the form-fit element 71 in the circumferential direction U around the output axis 15. The further form-fit elements 71 can each have a further form-fit surface 75. The form-fit surfaces 75 are arranged parallel to one another.

The form-fit elements 71 form a shaped collar 125, which extends in the circumferential direction U around the output axis 15 and assumes a partially circular extension in the circumferential direction U around the output axis 15, which by an angle of more than 210° and less than 240°, for example an angle of approximately 225°. The shaped collar 125 has a C-shaped extension and is formed from a plurality of form-fit elements 71 which extend in the circumferential direction U and are spaced apart from one another. The, in particular each, form-fit element 71, has an extension in the circumferential direction U around the output axis 15 and the, in particular each, form-fit element 71, has a distance in the circumferential direction U around the output axis 15 from a directly adjacent form-fit element 71, the distance being greater than the extension of the, in particular each, form-fit element 71. The, in particular each, form-fit element 71, extends in the circumferential direction U relative to the output axis 15 by an angular range of 25 to 35° and assumes, for example, an angle of approximately 30°.

The guard device 65 has a guard collar 127 which is provided to surround the accessory device 31 in portions or in the axial direction along the output axis 15 and in the circumferential direction U around the output axis 15. The guard collar 127 covers the accessory device 31 from a side facing the tool housing 25 and exposes the accessory device 31 from a side facing away from this side.

The guard device 65 has a connecting element 131 that is hollow-cylindrical in portions and connects the form-fit elements 71 forming the shaped collar 125 to the guard collar 127. The connecting element 131 extends in the circumferential direction U around the output axis 15 and in the axial direction along the output axis 15 and limits a radial extension of the guard device 65. On a side facing away from the guard collar 127 and the shaped collar 125 in the radial direction, the connecting element 131 has a contact surface 135 for resting the guard device 65 on the tool housing 25. The contact surface 135 defines a contact radius and is concentric to an outer surface of the tool housing 25.

The guard device 65 has a recess 51 which is arranged in the axial direction relative to the form-fit element 71. The recess 51 is arranged in the guard collar 127 and is assigned to the form-fit element 71 or is directly opposite it.

The guard device 65 is mounted to be rotatable about the output axis 15 on the guide device 79 of the tool housing 25. The guard device 65 can assume a plurality of rotational positions relative to the tool housing 25 and can be connected in a latchable manner to the tool housing 25 in these rotational positions.

The hand-held power tool 11 has a latching device 139, which is provided to adjust or define a rotational position of the guard device 65 relative to the tool housing 25 in the circumferential direction U around the output axis 15. The latching device 139 form-fittingly limits a rotational movement of the guard device 65 in the circumferential direction U in a clockwise direction and a counterclockwise direction.

The latching device 139 has a stop element 161, 163 which limits a rotational movement of the guard device 65 relative to the tool housing 25 of the hand-held power tool 11. The stop element 161 extends in the radial direction relative to the output axis 15 and forms a stop surface in order to form a form-fit stop of the guard device 65 relative to the tool housing 25 or the bearing housing 55. The stop should preferably form a barrier with a counter stop. Analogously to the stop element 161, the latching device 139 has a further stop element 163 which limits a rotational movement of the guard device 65 relative to the tool housing 25 of the hand-held power tool 11. The stop element 161 is arranged on a first side of the guard device 65. The further stop element 163 is arranged on a second side 37 of the guard device 65 facing away from the first side 35 in the circumferential direction U. The two stop elements 161, 163 have stop surfaces which face one another in the circumferential direction U, as a result of which the stop elements 161, 163 limit a rotational movement of the guard device 65 about the output axis in the circumferential direction U by means of a counter stop element designed as a latching pin.

The latching device 139 has a first latching element 151 which is arranged on the bearing housing 55. The first latching element 151 is designed as a latching pin and extends in the axial direction along the output axis 15 and projects relative to the tool housing 25. The first latching element 151 is mounted to be movable in the axial direction along the output axis 15 by means of a spring element. The first latching element 151 is arranged in a recess 51 of the tool housing 25 and is mounted to be movable along this recess 51. The first latching element 151 is intended to extend up to the guard device 65 and to contact said guard device and preferably to exert a force thereon in an operating state.

The latching device 139 has a second latching element 153 which is arranged on the guard collar 127 of the guard device 65 and extends in the circumferential direction U around the output axis 15 along a side surface of the guard device 65. The second latching element 151, 153 has a plurality of latching portions 167 which each form a latching position of the first latching element 151. The latching portions 167 are spaced apart from one another and extend along the second latching element 153 or in the circumferential direction U. The latching portions 167 are substantially circular in cross section in order to accommodate the first latching element 151 designed as a latching pin. The second latching element 153 is limited in the circumferential direction U around the output axis 15 by the stop elements 161, 163. The latching portions 167 are formed at the latching recesses into which the first latching element 151 can engage in order to latch the guard device 65 in a rotational position.

The guard device 65 can have a groove in which the second latching element 153, in particular the latching portion, is arranged.

The guard device 65 can have an unlocking recess which is provided to move the guard device 65 or the latching element designed as a latching pin out of a clamping position.

The tool housing 25 has an air inlet opening 171 and an air discharge opening 173, which are arranged directly adjacent to one another and which are arranged on the same side of the tool housing 25 or the drive casing 29. The air openings are provided on the drive casing 29 and extend substantially in a peripheral side of the drive casing 29. The air inlet opening 171 and the air discharge opening 173 can extend substantially in the circumferential direction U around the output axis 15 and at least partially in the axial direction along the output axis 15.

It is clear that the drive unit 13 has a fan unit, in particular surrounded by a motor housing 187, which is provided to generate an air flow, in particular an air input flow and an air output flow. For this purpose, the fan unit has an air wheel element which is driven, for example, by the drive unit 13, in particular the input shaft 19, in order to generate an air flow.

The hand-held power tool 11 has an air deflecting web 181 which separates the air inlet opening 171 from the air discharge opening 173. The air deflecting web 181 is provided to delimit an extension of the air inlet opening 171 and the air discharge opening 173. The air deflecting web 181 can be arranged between two housing openings 59.

The hand-held power tool 11 has a partition wall 183 which is provided to separate an air flow of the air inlet opening 171 from an air flow of the air discharge opening 173. The partition wall 183 adjoins the air deflecting web 181 or is delimited thereby in the radial direction relative to the output axis 15. The partition wall 183 extends from the air deflecting web 181 to the drive unit 13, in particular a motor housing 187 of the electric motor 33. Furthermore, a further partition 183 can be provided, which is spaced apart from the partition wall 183 in the axial direction along the input axis 17. The partition wall 183 is arranged upstream of the air discharge opening 173 in the axial direction and the further partition 183 is arranged downstream of the air discharge opening 173 in the axial direction. The partition walls are provided for forming a flow channel or a flow chamber for an air discharge opening 173 or an air discharge flow.

The partition wall 183 extends radially inward up to the drive unit 13 or a motor housing 187 of the electric motor 33. The partition 183 can surround the drive unit 13 or the motor housing 187 of the electric motor 33 by 360° in one plane. The partition wall 183 can be provided to separate or seal off a flow chamber assigned to the air discharge opening 173 from a flow chamber assigned to the air inlet opening 171. The partition wall 183 is provided to surround the drive unit 13 by 360° in one plane.

The motor housing 187 of the drive unit 13 has an air entry opening 175 and an air exit opening 177.

The air entry opening 175 is provided to guide an air flow from the tool housing into the motor housing 187. The air entry opening 175 is arranged on an end face 35 of the motor housing 187 and is provided to guide an air flow along the input axis in the axial direction in order to cool the drive unit 13.

The air exit opening 177 is provided for conducting an air flow out of the motor housing 187 into the tool housing 25. The air exit opening 177 is arranged on a peripheral side of the motor housing 187 and is provided to guide an air flow in the radial direction relative to the input axis 17 out of the drive unit 13 in order to conduct a warm air flow as quickly as possible out of the drive unit 13 or the motor housing 187.

The drive unit 13 or the motor housing 187 has a further air entry opening 175 and a further air exit opening 177. The further air entry opening 175 is arranged on a side of the motor housing 187 facing away from the air entry opening 175. The further air exit opening 177 is arranged on a side of the motor housing 187 facing away from the air exit opening 177.

The air exit opening 177 of the motor housing 187 at least partially covers the air inlet opening 171. The air discharge opening 173 of the tool housing 25 is arranged opposite the air exit opening 177 in such a way that a section extending perpendicularly to the input axis 17 through the tool housing 25 intersects the air discharge opening 173 of the tool housing 25 and the air exit opening 177.

The air inlet opening 171 and the air discharge opening 173 are arranged on a side of the tool housing 25, in particular a drive casing 29, which faces away from an actuating element.

The tool housing 25 has a further air inlet opening 171 which is arranged on an end face 35, 37 of the drive unit 13 facing away from the air inlet opening 171 and is provided for cooling the gear unit 23, in particular the spur gear elements 23b. The air inlet opening 171 is preferably intended to provide an air flow for the further air entry opening 175 of the tool housing 25, in particular of the motor housing 187.

The tool housing 25 has two housing half-shells 41a, 41b forming the handle casing 27 with two ends 83, 85 facing away from one another and a connecting region 191 formed between the ends 83, 85, wherein the connecting region 191 is intended to connect the two housing half-shells 41a, 41b in a form-fitting and/or frictional manner by means of a snap connection.

The snap connection is formed from a snap elements 193a, 193b and a holding element accommodating the snap elements 193a, 193b. In the present case, the snap connection has two snap elements 193a, 193b which are arranged on two sides of a first housing half-shell 41a, 41b facing away from one another. The snap elements 193a, 193be project from the first housing half-shell 41a, 41b and extend in the direction of the second housing half-shell 41a, 41b, as a result of which the snap elements 193a, 193b delimit an extension of the first housing half-shell 41a, 41b. The snap elements 193a, 193b are provided to project into the further housing half-shell 41a, 41b in an assembled state and to be accommodated with the holding element designed as a counter-snap element 195.

The snap elements 193a, 193b each have a snap hook 199, which is intended to be accommodated in a holding recess of the holding element. The snap elements 193a, 193b each have a snapping means 197. The snapping means 197 is arranged between the snap hook 199 and the first housing half-shell 41a, 41b. The snapping means 197 is provided to mount the snap hook 199 resiliently. The snapping means 197 is provided to deflect the snap hook 199 elastically into a deflection state from an initial state and to return it to the initial state by means of elastic energy.

The snapping means 197 is provided to connect the second housing half-shell 41b in a form-fitting manner in a direction perpendicular to the latching means. The latching means rest against the second housing half-shell 41b and contact them directly. The snapping means 197 or the snap elements 193a, 193b can pre-tension the second housing half-shell 41a, 41b in a tensioning direction in each case which are oriented facing away from one another. In this case, a pre-tensioning can be applied to the second housing half-shell 41b by means of the first housing half-shell 41a. By means of the snap elements 193a, 193b, which extends into the second housing half-shell 41a, 41b, a lateral relative movement of the housing half-shells 41a, 41b can be particularly advantageously pre-tensioned.

The snap connection is arranged directly adjacent to a battery unit 39. By using the snap elements 193a, 193b, a very flat and space-saving connection of the two housing half-shells 41a, 41b may be realized.

A section running perpendicular to a longitudinal extension of the handle casing 27 intersects the snap connection and the battery unit 39.

The two housing half-shells 41a, 41b are connected at the two ends 83, 85 by means of a screw connection 57a, 57b.

1. A hand-held power tool, comprising:
a tool housing comprising:
a handle casing for holding the hand-held power tool;
a drive casing; and
a bearing surface configured to be rested on a workpiece to be machined; and
a drive unit accommodated in the drive casing, the drive unit comprising:
an input shaft; and
an output shaft is arranged on a side of the input shaft which faces away from the handle casing.

2. The hand-held power tool according to claim 1, wherein maximum cutting depth of the hand-held power tool is adjustable depending on an angular position, of the hand-held power tool relative to the workpiece.

3. The hand-held power tool according to claim 1, wherein the maximum cutting depth is controllable by a rotational movement of the hand-held power tool about the output axis relative to a workpiece.

4. The hand-held power tool according to claim 1, wherein the tool housing has a first bearing region and a second bearing region, the first and second bearing regions each defining a respective distance from the output axis.

5. The hand-held power tool according to claim 1, further comprising:
a support device configured to support the hand-held power tool in an operating state and to limit a maximum cutting depth T of the accessory device.

6. The hand-held power tool according to claim 5, wherein the support device has a first support element which is arranged on the tool housing, extends parallel to the output axis, and is spaced apart from the output shaft in an axial direction along the output axis.

7. The hand-held power tool according to claim 1, characterized by further comprising:
a support device formed by a guard device of the hand-held power tool, the support device configured to support the hand-held power tool in an operating state.

8. The hand-held power tool according to claim 1, further comprising:
a bearing housing configured to surround, at least in portions, two housing half-shells that form the tool housing and to connect the two housing half-shells in a form-fitting manner.

9. The hand-held power tool according to claim 8, wherein the bearing housing is configured to cover a recess in the housing half-shells and/or has a guide device configured to accommodate a guard device and to mount the guard device to be movable about the output axis.

10. The hand-held power tool according to claim 1, wherein the tool housing defines an air inlet opening and an air discharge opening, which are arranged adjacent to one another with an air deflecting web separating the air inlet opening from the air discharge opening.

11. The hand-held power tool according to claim 1, wherein the drive casing has a height in a plane running parallel to the input axis and the output axis, and the accessory device has a maximum diameter, the height of the drive casing being greater than the maximum diameter of the accessory device.

12. The hand-held power tool according to claim 1, wherein the output axis of the output shaft intersects the drive unit.

13. The hand-held power tool according to claim 1, further comprising:
a gear unit comprising a spur gear element of the output shaft, wherein:
the tool housing defines a recess configured to at least partially accommodate the spur gear element; and/or
the spur gear element projects at least in portions in a radial direction relative to the recess and/or housing half-shells which form the tool housing.

14. The hand-held power tool according to claim 1, further comprising:
a bearing unit configured to mount the output shaft relative to the drive unit with a section extending transversely to the output axis through the bearing unit intersecting the input shaft and the output shaft.

15. A system comprising:
a hand-held power tool comprising:
a tool housing comprising:
a handle casing for holding the hand-held power tool;
a drive casing; and
a bearing surface configured to be rested on a workpiece to be machined; and
a drive unit accommodated in the drive casing, the drive unit comprising:
an input shaft; and
an output shaft arranged on a side of the input shaft which faces away from the handle casing; and
an accessory device,
wherein the accessory device projects in a radial direction relative to the drive casing on a side of the hand-held power tool facing away from the handle casing and/or does not project in the radial direction relative to the drive casing on a side of the hand-held power tool facing the handle casing.

16. The hand-held power tool according to claim 1, further comprising a battery unit via which the drive unit is operated, wherein:
the hand-held power tool is an angle grinder;
the drive casing is arranged on the handle casing; and
wherein the input shaft is rotatably mounted about an input axis and the output shaft is rotatably mounted about an output shaft.

17. The hand-held power tool according to claim 5, wherein the support device is formed by the tool housing.

18. The hand-held power tool according to claim 6, wherein the first support element is arranged on a housing half-shall of the tool housing.

19. The hand-held power tool according to claim 14, wherein the bearing unit is configured to mount the output shaft relative to the input shaft with the section extending perpendicularly to the output axis through the bearing unit.

20. The system according to claim 15, wherein the accessory device is a cutting disk.
